(19) United States
(12) Patent Application Publication
(10) Pub. No.: US 2025/0279485 A1
(43) Pub. Date: Sep. 4, 2025

(54) Multiple-Electron Aqueous Battery

(71) Applicants: University of Maryland, College Park, College Park, MD (US); U.S. Army Research Laboratory, Adelphi, MD (US)

(72) Inventors: Chunsheng WANG, Silver Spring, MD (US); Kang XU, Potomac, MD (US); Liumin SUO, Greenbelt, MD (US)

(73) Assignees: University of Maryland, College Park, College Park, MD (US); U.S. Army Research Laboratory, Adelphi, MD (US)

(21) Appl. No.: 18/774,738

(22) Filed: Jul. 16, 2024

Related U.S. Application Data
(63) Continuation of application No. 15/114,997, filed on Jul. 28, 2016, now Pat. No. 12,057,555.
(60) Provisional application No. 61/932,556, filed on Jan. 28, 2014.

(51) Int. Cl. H01M 10/36; H01M 4/46; H01M 4/48; H01M 4/485

(52) U.S. Cl. CPC H01M 10/36; H01M 4/466; H01M 4/48; H01M 4/485; H01M 2200/20; H01M 2220/20; H01M 2300/0002

(57) ABSTRACT

The present invention is directed to a hybrid high voltage aqueous electrolyte battery that combines Ni/Mg₂NiH₄ and Mg-ion rechargeable battery chemistries. The hybrid aqueous electrolyte battery can be used for plug-in hybrid electrical vehicles and electric vehicles.

### CROSS-REFERENCE TO RELATED APPLICATIONS

This application is a continuation of U.S. patent application Ser. No. 15/114,997, filed Jul. 28, 2016, which is a U.S. National Stage Application, filed under 35 U.S.C. § 371, of International Patent Application No. PCT/US2015/13322, filed on Jan. 28, 2015, which claims the benefit of U.S. Provisional Patent Application No. 61/932,556, filed Jan. 28, 2014, all of which are incorporated by reference herein in their entirety.

### STATEMENT REGARDING FEDERALLY SPONSORED RESEARCH OR DEVELOPMENT

This invention was made with government support under DE-AR0000389 awarded by the Department of Energy. The government has certain rights in the invention.

### BACKGROUND OF THE INVENTION

### Field of the Invention

The present invention is directed to a hybrid high voltage aqueous electrolyte battery that combines Ni/Mg₂NiH4 and Mg-ion rechargeable battery chemistries. The hybrid aqueous electrolyte battery can be used for plug-in hybrid electrical vehicles and electric vehicles.

### Background

Automotive batteries for hybrid electric vehicles (HEV), plug-in hybrid electric vehicles (PHEV), and battery electric vehicles (BEV) should possess an energy density high enough for a 300 mile-range per charge, cost less than $100/kWh, and be robust, as well as safe, against various abuses experienced on the road. Li-ion batteries (LIB) based on organic non-aqueous electrolytes provide the highest energy density available among all rechargeable systems; however, their high cost and the hazardous nature of the electrolyte systems fail to satisfy the above requirements. To prevent catastrophic thermal runaway, battery management systems using thermal and electronic control on both a cell and pack level have to be employed, which not only increases the cost and but also reduces the overall device energy density. Solid state electrolyte LIBs are relatively safe, but they show low ionic conductivity of the glassy or ceramic solid electrolyte and have inferior (point-to-point) contact between the solid/solid interface as compared with the solid/liquid (surface-to-surface) interface of conventional batteries. Solid state electrolyte LIBs largely restrict the power density of the devices. To cope with the low conductivity (about 10⁻⁴−10⁻⁶ S/cm), a very thin film (<50 micron) has to be used, which places a limit on the mechanical robustness. In addition, the high interfacial solid/solid resistance between the solid electrode and solid electrolyte continuously deteriorates with charge/discharge cycles, because the large volume change of the two electrodes upon lithiation/delithiation cannot be accommodated by the rigid solid electrolyte with fixed volume. These mechanical strains will eventually lead to failure of the cell configuration.

Solid-state LIBs are fundamentally different from a solid oxide fuel cell (SOFC), where no volume change is expected. This is the inherent reason why the mature ceramic electrolytes from solid-oxide fuel cells cannot be directly borrowed and applied to battery technologies. Thus, the all-solid-state batteries have been limited to the niche market of small format storage units for on-board memory backup, while their deployment as large format automotive batteries remains remote. Flow batteries employing liquid or slurry-based reactants enabled physical isolation of active materials from the cell reaction sites, with improved safety and reduced cost. However, the specific energy density of flow batteries is low, mainly due to limitations of solubility and operating potentials of active materials, as well as the inert mass of infrastructures (reservoirs, pipings, and pumps) (see Duduta, M., et al., Adv. Energy Mater. 1:511-516 (2011)). On the other hand, rechargeable batteries using aqueous electrolytes are also intrinsically safe, as exemplified by alkaline nickel/metal-hydride batteries that have been used in hybrid electric vehicles (see Liu, Y., et al., J. Materials Chem. 21:4743-4755 (2011)). However, their energy density compared with LIBs still falls below the requirement for an ideal electric vehicle.

The cell voltage of aqueous batteries is confined by the narrow thermodynamic electrochemical stability window of water (1.23 V). However, this window can be increased by kinetically suppressing the evolution of H₂ and O₂. By increasing the ion solvation in neutral electrolytes (pH=7), the aqueous battery and supercapacitor can usually be charged to 2.0-2.50 V with almost 100% coulombic efficiency and a cycle life of more than 1000 with a low self-discharge rate (see Yang, J., et al., J. Power Sources 218:222-236 (2012) and Fic, K., et al., Energy Environ. Sci. 5:5842-5850 (2012)). In addition, 2.0 V lead-acid batteries have been commercialized and widely used as starter batteries in automobiles. Although the expanded 2.0-2.5 V voltage of aqueous batteries is still lower than the typical 3.5-4.0 V for LIBs, a comparable energy density could still result with sufficient compensation from capacities.

Compared with their non-aqueous counterparts, aqueous electrolytes have the advantages of low cost, high safety, high conductivity, low viscosity, easy manipulation, and environmental “greenness.” The aqueous electrolytes in rechargeable batteries normally use either concentrated acidic or alkaline solution (e.g., 10 M H₂SO₄ or 6 M KOH) to achieve maximum ionic conductivity. However, they are too caustic to handle and rather corrosive toward cell packaging materials. Due to the typical high conductivities of aqueous systems, benign neutral aqueous solutions based on safe and highly soluble alkali salts can still meet the requirements of a battery; however, as less corrosive solutions. Thermodynamically, the electrochemical stability window of water does not change with pH value, but the real voltage window of neutral aqueous electrolyte can be expanded more easily. In such a neutral electrolyte, the H⁺/OH⁻ equilibrium is not shifted to favor either species therefore evolution of H₂ or O₂ could be minimized. In an electrolyte, both cations and anions are associated to water to form solvation shells. The strong solvation allows more water molecules to be strongly associated to cations and anions, thus suppressing their activities in decomposition and consequently enlarging the electrolyte stability voltage window. For example, in a Li₂SO₄ electrolyte, Li⁺ is surrounded by 27 molecules of water, while the sulfate anion, SO₄²⁻, can solvate 17 molecules of water with a large hydration energy—on the order of 160-220 kJ/mol (Fic, supra). In highly concentrated electrolytes, only a few “free” water molecules would remain; hence minimizing the oxidation and reduction, and the aqueous stability window can be largely enlarged. For example, in a 1 M Li₂SO₄ electrolyte, the stable electrochemical window of the Li₂SO₄ electrolyte can be enlarged to 2.2 V (Fic, supra). The stable electrochemical window of an aqueous Li₂SO₄ electrolyte can be further enlarged if a saturated Li₂SO₄ electrolyte is used. The solvation capability of different salts has been investigated and might serve as quantification to evaluate their effectiveness in minimizing water decomposition. It was reported that the solvation capability of alkali metal ions increases with the increase of the ion-solvent complex diameter in the order K⁺<Na⁺<Li⁺ (Fic, supra). Among the anions, the sulfate anion, SO₄²⁻, is one of the biggest and strongest solvated inorganic anions, with a desolvation energy of about 108 kJ/ml per one SO₄²⁻−H₂O bond (Fic, supra).

The water activity in an aqueous electrolyte can be further reduced by increasing the salt concentration beyond the saturation value through a “water-in-salt” concept of a solid electrolyte, which has not been reported previously. The “water-salt-electrolyte” is similar to the concepts of “solvent-in-salt” and “polymer-in-salt” that have been proposed. For example, an electrolyte with ultrahigh salt concentration was used in organic electrolyte Li—S batteries in order to suppress lithium dendrite growth and prevent lithium polysulphide dissolution (Suo, L., et al., Nature Communications 4:1481 (2013)). In such “solvent-in-salt” electrolytes, the lithium-ion transference numbers were far higher (0.73) than their diluted counterparts although the Li-ion conductivity was shown to be reduced to 10⁻³ S/cm. The uniqueness of “water-in-salt” electrolytes is that the disadvantage of lowering the ionic conductivity is not an issue for an aqueous electrolyte because an aqueous electrolyte has a much higher conductivity than an organic electrolyte and the ionic conductivity of an aqueous electrolyte is not very sensitive to the salt concentration. The ionic conductivity of a “water-in-salt” aqueous electrolyte should be higher than that of an organic electrolyte.

With increased salt concentration, the volume of each charge carrier (hydrated ions) will shrink as the hydration number becomes smaller and solvated ions form aggregates. The smaller charge carrier leads to higher conductivity, but their aggregation increases the viscosity, thus retarding the mobility of ions. Overall, concentration changes have only a minor effect on the ionic conductivity of a Li₂SO₄ electrolyte. For example, when the concentration of a Li₂SO₄ electrolyte increases from 0.1 M to 4 M, the change of ionic conductivity was smaller than 20 mS/cm (i.e., from 30 mS/cm at 0.1 M to 50 mS at 2 M, and 40 mS/cm at 4 M) (Fic, supra). An additional benefit from using a concentrated aqueous electrolyte is the wide service temperature range, which is required for automotive batteries. This was shown by the melting point depression incurred from using H₂O—ion interactions (Yin, J., et al., J. Power Sources 196:4080-4082 (2011)). Furthermore, a 3 V stable electrochemical window was achieved by using a ceramic lithium super-ionic conductor (Li_{1+x+y}AlₓTi₂₋ₓSi_{y}P_{3y}O₁₂ (LATSP)) thin film to separate the acidic electrolyte from the alkaline electrolyte to form an acidic-alkaline double electrolyte junction (Chen, L., et al., Chem. Commun. 49:2204-2206 (2013)). However the poor reliability and safety concerns associated with this type of battery limited its application for electric vehicles.

An alternative method to enlarge the stability window of aqueous electrolytes is to employ additive materials that have high overpotentials for either hydrogen-evolution at the anode or oxygen-evolution at the cathode. Pb, Cd, Zn, and Sn are the most effective examples of these additive materials in suppressing hydrogen evolution at negative electrodes, while carbon along with some metal oxides prove useful for suppressing oxygen evolution.

The most successful aqueous batteries are lead-acid batteries and alkaline Ni/MH batteries. However the lead-acid batteries are only used as starter/lighting power sources in most automobiles due to low energy densities (about 10-20 Wh/Kg). Although Ni/MH batteries have higher energy density and have been used as an energy storage component in hybrid electric vehicle power systems, their energy densities are far below those required for electric vehicle applications. In addition, the limited and uneven distribution of rare earth metals globally (a key component in MH electrodes) also raises a concern for national security wherein prices could be manipulated by hostile geopolitical forces.

Mg-based alloys, on the other hand, are very promising hydrogen storage host materials for battery applications, exemplified by Mg₂NiH₄, whose theoretical capacity (1001 mAh/g) is almost 3 times higher than that of AB₅H₆ (370 mAh/g), and whose abundance in the earth's crust essentially eliminates any concern over sustainability (Liu, supra).

Ni(OH)₂ can also serve as an active cathode for a metal-hydride battery. In a Ni/MH battery (FIG. 1), the energy storage metal (M) negative electrode can be electrochemically hydrogenated/dehydrogenated during charge/discharge by the following reaction:

M+H₂O+e⁻↔MH+OH⁻

While the following reaction will take place in the Ni positive electrode:

Ni(OH)₂+OH↔NiOOH+H₂O+e⁻

In Mg-based alloys, Mg serves as the main hydrogen storage element (2200 mAh/g for MgH₂), and the alloyed metals (Ni, Fe, Mn, Co, Cu, AI, Ti, V, Cr, etc.) in Mg-based alloys functions as the hydriding/dehydriding accelerator and corrosion resistor in the alkaline electrolyte. Even through 30% Ni is added into Mg (such as Mg₂Ni), the Mg-based hydrogen storage electrodes still suffer from poor cycling stability due to the continuous corrosion of Mg in the 6 M alkaline electrolyte, which forms a dense Mg(OH)₂ layer on the Mg in the alkaline electrolyte and inhibits sustaining reactions. The corrosion of Mg₂Ni is because the formation potential of Mg₂Ni is lower than the hydrogen evolution potential. If the hydrogen evolution potential on Mg-based electrodes could be pushed below the formation potential of the alloy by manipulating salt solvation and concentration, there is a chance to stabilize the Mg-based anode in Ni/MH batteries. This would increase the capacity of NiMH due to the 3 times greater capacity of Mg-based MH than AB₅ based MH currently used in Ni/MH batteries, and provide energy density comparable to current Li-ion batteries since the capacity (1001 mAh/g) of Mg₂Ni is almost three times higher than the capacity of graphitic anodes in Li-ion battery, compensating for the loss due to the lower voltage (2.0-2.5 V) of Ni/MgNi₂H₄ as compared with LIB.

Shifting H₂ evolution potential negatively to reduce the corrosion of Mg in an electrolyte has been demonstrated in an aqueous primary Mg-air battery (see Winther-Jensen, B., et al., Electrochemica Acta 53:5881-5884 (2008) and Kong, Y., et al., Synthetic Metals 162:584-589 (2012)). Winther-Jensen reported that the hydrogen evolution potentials were shifted to a more negative value by (1) mixing 50% strong solvated LiCl with MgCl; (2) increasing the pH value from 7 to 11; and (3) increasing the concentration of MgCl salt from 1 M to saturation (Winther-Jensen, supra). The negative shift of H₂ evolution potential enhanced the discharge capacity and working voltage of Mg-air batteries (Winther-Jensen, supra) due to the retarded corrosion rate of Mg. The suppression of hydrogen evolution on Mg in aqueous electrolyte was also confirmed through visual inspection of an Mg specimen immersed in highly concentrated salt solutions, which did not engender significant gas evolution as usually observed upon immersion of Mg in diluted aqueous solutions (Winther-Jensen, supra). Since Mg-M alloys provide more positive potential than Mg, it is easier to stabilize Mg-Malloy anodes in an aqueous electrolyte by using highly solvated salts and increasing the salt concentration.

The capacity of aqueous Ni/Mg₂Ni batteries (FIG. 1) can be further increased if the cathode and anode can be in situ electrochemically formed by Mg²⁺ insertion/extraction between anode and cathode in aqueous electrolyte employing Mg-ion battery chemistry. For example, Mg₂Ni can be formed by Mg²⁺ insertion into Ni in an aqueous electrolyte providing extra capacity. The enabling of the “hybrid cell chemistries” concept allows the combined capacities of both Mg-ion battery and Ni/MH battery to be accessed, leading to an energy density up to 2 times higher than that of current Li-ion batteries.

As the 5th among the top 40 most abundant elements in the earth's crust, Mg provides long-term sustainability, and is environmentally benign so it can be handled in an uncontrolled ambient atmosphere. Being a bivalent cation, its specific volumetric capacity reaches 3833mAh/cc, higher than that for Li metal (2046 mAh/cc). State-of-the-art Mg-ion battery technology uses an organic electrolyte with an electrochemical stable window of 2.0-3.0 V (Yoo, H. D., Energy & Environmental Science 6:2265-2279 (2013)), just slightly higher than that of a saturated aqueous electrolyte.

Many metals can electrochemically alloy with Mg at different potentials and serve as anodes for a Mg-battery. Arthur and co-workers reported that Bi, Sb, and alloys thereof reversibly reacted with a Mg-ion to form alloys at 0.3 V vs. Mg/Mg²⁺(x<0.45) alloys which showed a very stable cycle ability in electrochemical alloying/de-alloying with Mg for 100 cycles with 222 mAh/g at the 100th cycle (Arthur, T. S., et al., Electrochem. Commun. 16:103-106 (2012)). Tin (Sn) powder electrodes can also react with Mg-ion at 0.2 V vs. Mg/Mg²⁺, delivering 200-300 mAh/g at a slow rate (<0.05 C) (Singh, N., et al., Chem. Commun. 49:149-151 (2013)). As shown in FIG. 2, a metal with Mg²⁺ insertion potential above 0.7 V can be safely used as dual chemistry anodes in the aqueous electrolyte at a pH of about 11 when the electrochemical stability window of aqueous electrolyte can be enlarged to 2.5-3.0 V. It is known that increasing the pH value can reduce the Hz evolution potential (FIG. 2), but if the pH is higher than 11, solid Mg(OH) may form on the Mg surface, reducing the reaction kinetics.

In the examples presented, the equilibrium potential of a few metals alloying with Mg-ion were measured and it was identified that Mg-ions can alloy with Ni to form Mg₂Ni at 1.5 V vs. Mg/Mg²⁺ in saturated MgSO₄-Li₂SO₄ (1:1) aqueous electrolyte, and the formed Mg₂Ni can absorb hydrogen during further charging in the same aqueous electrolyte to form Mg₂NiH₄, which validated the “hybrid cell chemistries” concept, in which successive reactions of Mg²⁺ into Ni followed by H⁺ insertion into the formed Mg₂Ni in saturated aqueous electrolyte occurred.

On the other hand, some metal oxides and sulfides can react with Mg-ion at a high potential, which makes them candidates as Mg-ion battery cathode materials. Typical examples are Chevrel phase MxMo3T4 (M=metal, T=S, Se) (Levi, E., et al., Journal of Electroceramics 22:13 (2009)), vanadium oxides (Imamura, D., et al., J. Electrochemical Society 150:A753 (2003) and Novak, P., et al., Electrochimica Acta 45:351 (1999)), TiS₂ nanotubes (Tao, Z., et al., Chem. Commun. 2080 (2004)), mesoporous Mg_{1.03}Mn_{0.97}SiO₄ and graphite-like MoS₂ (Liang, Y., et al., Advanced Materials 23:640 (2011)), Co₃O₄ (Sutto, T. E., Electrochimica Acta 80:413-417 (2012)), and MnO₂ (Rasul, S., et al., Electrochimica Acta 82:243-249 (2012); Zhang, R., et al., Electrochemistry Commun. 23:110-113 (2012); and Rasul, S. et al., Solid State Ionics 225:542-546 (2012)). Among these, only MnO₂ can react with both Mg-ion and H-ion at potentials where aqueous electrolyte remains stable.

Mg-ion can insert into MnO₂ according to the following formula:

2 MnO₂+Mg²⁺+2 e⁻↔2 Mg_{0.5}MnO₂

providing a capacity of 200-470 mAh/g (MgₓMnO₂; x=0.4-0.8) in organic electrolyte in potential ranges of 2.0-3.3 V vs. Mg/Mg²⁺, which is within the stability window of aqueous electrolytes as shown in FIG. 2.

MnO₂ has also been used in aqueous battery cathodes to reversibly store protons at a potential slightly below the Mg-ion insertion potential (Chen, L., Chem. Commun. 49:2204-2206 (2013)) as shown by the following formulas:

MnO₂+H⁺+e⁻↔MnOOH (for pH<7)

MnO₂+H₂O+e⁻↔MnOOH+OH⁻(for pH>7)

MnOOH+H⁺+e⁻↔Mn(OH)₂ (for pH<7)

MnOOH+H₂O+e⁻↔Mn(OH)₂+OH⁻(for pH>7)

Thus, a Mg_{0.5}MnOOH cathode could couple with a Ni anode and organic electrolyte to form a full cell. If the organic electrolyte is used as in a conventional Mg battery, only Mg²⁺ transports between the Mg_{0.5}MnOOH cathode and the Ni anode (FIG. 3). During charge, Mg²⁺ transports between the Mg_{0.5}MnOOH cathode to alloy with Ni at anode to form Mg₂Ni, and then upon discharge Mg²⁺ moves back from Mg₂Ni to Mg_{0.5}MnOOH, delivering the “Mg-ion battery” capacity (FIG. 3). However, according to the present invention, if saturated and “water-in-salt” aqueous electrolytes are used, both Mg²⁺ and H⁺ will successively transport between the Mg_{0.5}MnOOH cathode and the Ni anode (FIG. 4), delivering the capacity of “hybrid cell chemistries.”

For a hybrid cell, during charge, Mg²⁺ and then H⁺ extracted from the Mg_{0.5}MnOOH cathode transport through the aqueous electrolyte and then successively insert into the Ni anode to first form Mg₂Ni and then Mg₂NiH₄, while the Mg_{0.5}MnOOH cathode changes to MnOOH and then to MnO₂. During discharge, a reversal reaction takes place (FIG. 4).

Despite the numerous advantages of aqueous Li-ion chemistry—including superior safety, low environmental impact, and low cost—the narrow electrochemical stability window of the water molecule (<1.5 V) imposes an intrinsic limit on the practical energy output from use of such a chemistry.

Since the advent of a commercial, non-aqueous, Li-ion battery (LiCoO₂/organic electrolyte/graphite) by Sony Company in 1991, Li-ion batteries gradually dominated the electrochemical storage market for several years relying on their distinct advantages of higher real energy density and longer cycling life (Armand, M. and Tarascon, J. M., Nature 451:652-657 (2008) and Whittingham, M. S., Chemical Reviews 104:4271-4301 (2004)).

In contrast to aqueous rechargeable batteries (Ni-MH and Pb-acid), non-aqueous Li-ion batteries are undesirable based upon safety considerations and their cost due to the inflammable organic electrolyte and the manufacturing process requiring strict moistureless conditions (Tarascon, J. M. and Armand, M., Nature 414:359-367 (2001); Goodenough, J. B.; Kim, Y., Chemistry of Materials 22 :587-603 (2010); and Xu, K., Chemical Reviews 104:4303-4417 (2004)).

Accounting for safety and cost-effective rations, aqueous Li-ion batteries were invented in 1993 (Li, W., et al., Science 264:1115-1118 (1994)). Unfortunately, progress in Li-ion battery chemistry has been very slow, even at a standstill at times, due to the bottleneck of aqueous electrolyte which presents the following problems: (1) the narrow stable thermodynamic and dynamic electrochemical window limits the output voltage of a full cell to less than 1.5 V (Wang, Y. G., et al., Advanced Energy Materials 2(7):830-840 (2012)); (2) the high hydrogen evolution potential restricts the choice of anode to a large extent and H₂ evolution in the full charge makes the stability of the anode deteriorate rapidly owing to self-discharge caused by side reaction between electrode and water (Li, W., et al., J. Electrochemical Society 141(9):2310-2316 (1994)); (3) the inevitable dissolving of oxygen in the aqueous electrolyte accelerates electrode fading (Luo, J.-Y., et al., Nature Chemistry 2(9):760-765 (2010)); and (4) the aqueous electrolyte decomposition cannot form a protective solid electrolyte interphase (SEI) on the electrode like an organic electrolyte. All of the reasons mentioned above cause the relatively low real energy density (low output voltage), short cycling life (self-discharge), and low coulombic efficiency (water decomposition) in rechargeable aqueous lithium ion batteries.

To solve the problems inherent to Li-ion batteries, the most common approach is to reduce hydrogen evolution potential by adjusting the alkalinity of the electrolyte based on pourbaix diagrams (see Li, supra and Luo, supra), however, at the same time, the choice of cathode is also limited due to oxygen evolution potential which will also decrease in strong alkaline electrolyte. The other way is to increase overpotential of water decomposition by coating carbon/polymer on the electrode (Tang, W., et al., Energy & Environmental Science 5:6909-6913 (2012); Aravindan, V., et al., Physical Chemistry Chemical Physics 14(16):5808-5814 (2012); and Luo, J. Y., et al., Advanced Functional Materials 17(18):3877-3884 (2007)), but this dynamic improvement seems to just delay the electrode fading. Because, in the cycling process, the capacity retention is mainly determined by test time, the range of setting up test voltage and coulombic efficiency is sensitive to charge-discharge rate. All those phenomena reveal that aqueous electrolyte decomposition always exists in the whole charge-discharge process. Although a high voltage is desirable for achieving high energy density of a LIB, the practical output voltage and stability of electrode are at present limited by the stable electrochemical window of aqueous electrolyte. Thus, if we want to achieve high voltage and long cycling life, the research and development of stable aqueous electrolyte is generally considered to be fundamental.

There is tremendous room in improving the energy density of aqueous battery to levels comparable or even higher than those of Li-ion batteries, either by enlarging the electrochemical stability window of aqueous electrolytes or by increasing the electrode capacities.

The present invention provides an aqueous electrolyte entitled “water-in-LiTFSI” with a wide and stable electrochemical window (2.7 V) due to the formation of a full Li-ion-H₂O complex with strong solvation energy and stable protective SEI layer on the anode in the first discharge. In this system, the hydrogen evaluation potential can extend to −1.3 V vs. Ag/AgCl reference in neutral solution. Full cell (LiMn₂O₄/water-in-Salt/Mo₃S₄) presents ultrahigh output voltage (>2.0 V), super-long stable cycling life both in low rate (0.15 C) and high rate (4.5° C.), and nearly 100% coulombic efficiency with an energy density which could be achieved of 100 Wh/kg based on the total mass of cathode and anode.

### BRIEF SUMMARY OF THE INVENTION

In some embodiments, the present invention provides an electrochemical cell comprising:
(a) an anode;
(b) a cathode; and
(c) a water-in-salt electrolyte.

In some embodiments, the cathode comprises Mg_{0.05}AOOH, wherein A is a metal or an alloy of a metal. In some embodiments, A is a metal selected from the group consisting of Li, Mg, Mn, Co, Ti, Zn, Al, Zn, Cr, Fe, Ni, Sn, Pb, H, Cu, Ag, Pd, Hg, Pt, Bi, Zr, and Au or is an alloy of a metal selected from the group consisting of Li, Mg, Mn, Co, Ti, Zn, Al, Zn, Cr, Fe, Ni, Sn, Pb, H, Cu, Ag, Pd, Hg, Pt, Bi, Zr, and Au. In some embodiments, A is Mn, Co, Ni, or Fe.

In some embodiments, the anode comprises Mg₂M, wherein M is a metal or an alloy of a metal. In some embodiments, M is selected from the group consisting of Li, Mg, Mn, Co, Ti, Zn, Al, Zn, Cr, Fe, Ni, Sn, Pb, H, Cu, Ag, Pd, Hg, Pt, Bi, Zr, and Au or is an alloy of a metal selected from the group consisting of Li, Mg, Mn, Co, Ti, Zn, Al, Zn, Cr, Fe, Ni, Sn, Pb, H, Cu, Ag, Pd, Hg, Pt, Bi, Zr, and Au. In some embodiments, M is Fe, Ni, Mn, Co, Al, Zn, Sn, Bi, Zr, or Cu or is an alloy of a metal selected from the group consisting of Fe, Ni, Mn, Co, Al, Zn, Sn, Bi, Zr, or Cu. In some embodiments, M is Ni.

In some embodiments, the salt in the water-in-salt electrolyte is a sulfone-based salt.

In some embodiments, the salt in the water-in salt electrolyte is selected from the group consisting of LiN(SO₂CF₃)₂, LiN(SO₂CH₃)₂, LiN(SO₂C₄H₉)₂, LiN(SO₂C₂F₅)₂, LiN(SO₂C₄F₉)₂, LiN(SO₂F₃)(SO₂C₄F₉), LiN(SO₂C₂F₅)(SO₂C₄F₉, LiN(SO₂C₂F₄SO₂), LiN(SO₂C₂F₄SO₂), LiN(SO₂F)₂, and LiN(SO₂F)(SO₂CF₃).

In some embodiments, the salt in the water-in-salt electrolyte is LiN(SO₂CF₃)₂.

In some embodiments, the amount of water in the water-in-salt electrolyte is between 20% and 100% (by volume). In some embodiments, the amount of water in the water-in-salt electrolyte is between 30% and 100% (by volume). In some embodiments, the amount of water in the water-in-salt electrolyte is between 40% and 100% (by volume).

In some embodiments, the water-in-salt electrolyte has a pH between 7 and 11.

In some embodiments, the cell has an operating temperature between −40° C. and 100° C. In some embodiments, the cell has an operating temperature between −40° C. and 70° C.

In some embodiments, the cell has a full cell voltage output between 1.5 V and 4.0 V. In some embodiments, the cell has a full cell voltage output between 1.8 V and 4.0 V.

In some embodiments, the present invention provides an electrochemical cell comprising:
(a) an anode;
(b) a cathode comprising Mg_{0.05}AOOH, wherein A is a metal or an alloy of a metal; and
(c) an aqueous electrolyte.

In some embodiments, A is a metal selected from the group consisting of Li, Mg, Mn, Co, Ti, Zn, Al, Zn, Cr, Fe, Ni, Sn, Pb, H, Cu, Ag, Pd, Hg, Pt, Bi, Zr, and Au or is an alloy of a metal selected from the group consisting of Li, Mg, Mn, Co, Ti, Zn, Al, Zn, Cr, Fe, Ni, Sn, Pb, H, Cu, Ag, Pd, Hg, Pt, Bi, Zr, and Au. In some embodiments, A is Mn, Co, Ni, or Fe.

In some embodiments, the aqueous electrolyte is a water-in-salt electrolyte.

In some embodiments, the salt in the aqueous electrolyte is a sulfone-based salt.

In some embodiments, the salt in the aqueous electrolyte is selected from the group consisting of LiN(SO₂CF₃)₂, LiN(SO₂CH₃)₂, LiN(SO₂C₄H₉)₂, LiN(SO₂C₂F₅)₂, LiN(SO₂C₄F₉)₂, LiN(SO₂F₃)(SO₂C₄F₉), LiN(SO₂C₂F₅)(SO₂C₄F₉, LiN(SO₂C₂F₄SO₂), LiN(SO₂C₂F₄SO₂), LiN(SO₂F)₂, and LiN(SO₂F)(SO₂CF₃).

In some embodiments, the salt in the aqueous electrolyte is LiN(SO₂CF₃)₂.

In some embodiments, the amount of water in the aqueous electrolyte is between 20% and 100% (by volume). In some embodiments, the amount of water in the aqueous electrolyte is between 30% and 100% (by volume). In some embodiments, the amount of water in the aqueous electrolyte is between 40% and 100% (by volume).

In some embodiments, the aqueous electrolyte has a pH between 7 and 11.

In some embodiments, the present invention provides an electrochemical cell comprising:
(a) an anode comprising Mg₂M, wherein M is a metal or an alloy of a metal;
(b) a cathode comprising Mg_{0.05}AOOH, wherein A is metal or an alloy of a metal; and
(c) an water-in-salt electrolyte.

### BRIEF DESCRIPTION OF THE DRAWINGS

FIG. 1 is a scheme illustrating the electrochemical reaction process of a Ni/Mg₂NiH₄ battery in an alkaline electrolyte. During charge, the protons move from the Ni(OH)₂ through the aqueous electrolyte to the Mg₂Ni alloy to form Mg₂NiH₄. Upon discharge, the protons move away from the Mg₂NiH₄ alloy through the aqueous electrolyte to the NiOOH to form Ni(OH)₂.

FIG. 2 is a scheme illustrating the evolution potential and on the left side is the O₂/H₂ evolution potential versus normal hydrogen electrode (NHE) at different pHs for water and water-in-salt solutions. On the right side are the insertion potential for Mg²⁺ alloying into metals (M) to form Mg₂M and successive proton insertion potential of Mg₂M to form Mg₂MH₄ negative electrode, the potentials of Mg²⁺ extracting from MgₓA(OH)₂, wherein A is Mn, Ni, Co, Fe, and their alloys, to form A(OH)₂ positive electrode and successive proton extraction from A(OH)₂ to AOOH positive electrodes. The solid squares in the scheme represent electrode values reported in the literature and the dashed squares represent proposed electrode values.

FIG. 3 is a schematic illustrating the electrochemical reaction process of a Mg-ion battery in organic electrolyte.

FIG. 4 is a schematic illustrating the electrochemical reaction process of a Mg²⁺/H⁺ battery in a water-in-salt electrolyte. During charge, Mg ions in the Mg_{0.5}AOOH positive electrode travel from the electrolyte to the metal M (or alloy) negative electrode and form an AOOH positive electrode and Mg₂M negative electrode. Upon further charging, H⁺ in AOOH moves through the aqueous electrolyte into Mg₂M to form Mg₂NiH₄, releasing additional capacity. During discharge, a reverse reaction takes place.

FIG. 5 is a schematic presenting the advantages of hybrid batteries. Electrode potentials and stable electrochemical window of saturated (or water-in-salt) electrolyte and organic electrolyte are compared.

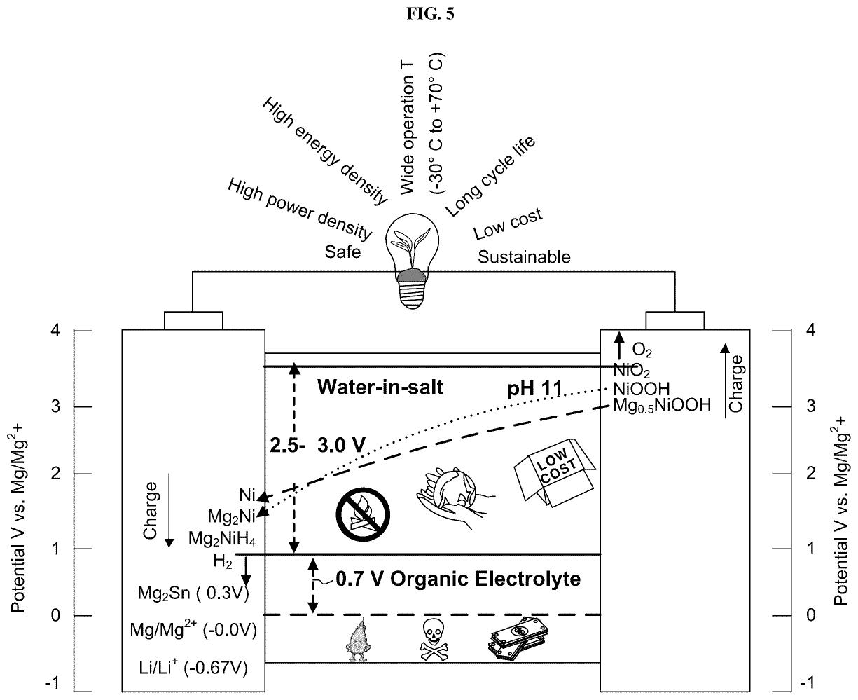

FIG. 6 is a graph depicting the electrochemical stability windows of a saturated Li₂SO₄-MgSO₄ (1:1) electrolyte and a water-in-salt (Li₂SO₄-MgSO₄ (1:1)) electrolyte measured using cycle voltammetry at a scan rate of 10 mV/s.

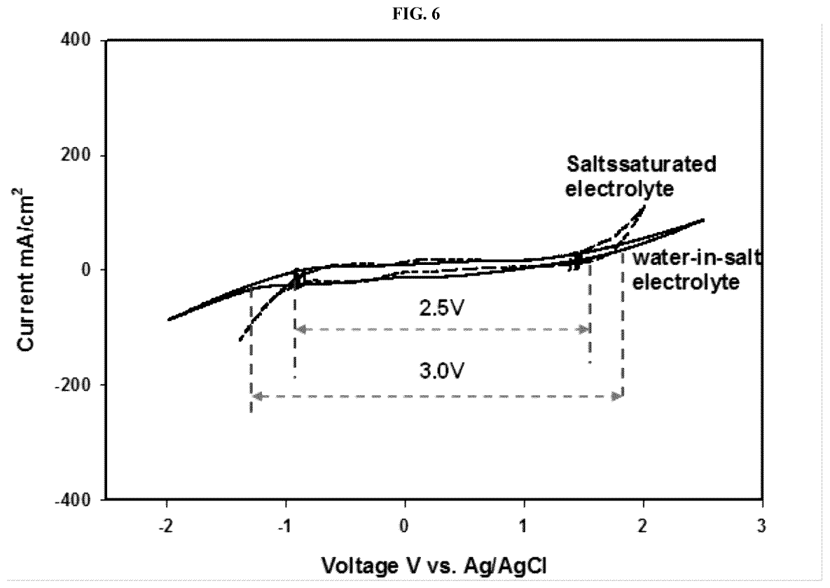

FIG. 7 is bar graph showing the ionic conductivity of different electrolyte measured using electrochemical impedance spectroscopy.

FIG. 8 is a graph showing the conductivity of a Li₂SO₄ electrolyte at different concentrations and temperatures.

FIG. 9A is a graph of a LiTFSI-H₂O electrolyte showing the weight and volume ratio of salt to solvent with the increase in electrolyte molarity.

FIG. 9B is a graph of a LiTFSI-H₂O electrolyte at different molarities (1 m, 5 m, 10 m, and 22.2 m) showing the Arrhenius relation of σ and 1000/T in a temperature range of between 10° C. to about 50° C.

FIG. 9C is a graph of a LiTFSI-H2O electrolyte showing the dissolved oxygen content, ionic conductivity, and viscosity at room temperature.

FIG. 9D is a graph of a LiTFSI-H₂O electrolyte at different molarities (1 m, 5 m, 10 m, and 22.2 m) showing the stable electrochemical window measured by cyclic voltammetry (1.8 to about −1.8 V vs Ag/AgCl, 10 mV/s).

FIG. 10A is a cyclic voltammetry plot showing measurements of Mo₃S₄ in different molarity electrolytes (5 m, 10 m, and 22.2 m) at 0.1 mV/s. The measurements follow the order 5 m, 10 m, and 22.2 m and the scanning potential range is set up at −1.05 to about 0 V.

FIG. 10B is a cyclic voltammetry plot showing measurements of LiMn₂O₄ in different molarity electrolytes (5 m, 10 m, and 22.2 m) at 0.1 mV/s. The measurements follow the order 5 m, 10 m, and 22.2 m and the scanning potential range is set up at 0.5 to about 1.3 V.

FIG. 10C is a plot showing cyclic voltammetry measurements of Mo₃S₄ with a 22.2 m electrolyte at a scanning rate of 0.1 mV/s.

FIG. 11A is a graph of the discharge-charge profile of LiMn₂O₄ at 0.2 C in a 22.2 m electrolyte in three-electrode devices.

FIG. 11B is a graph of the discharge-charge profile of Mo₃S₄ at 0.2 C in a 22.2 m electrolyte in three-electrode devices.

FIG. 12A is a graph depicting the charge/discharge of LiMn₂O₄/Mo₃S₄ full cell in a water-in-salt electrolyte.

FIG. 12B is a graph depicting the electrochemical performances of LiMn₂O₄/Mo₃S₄ full cell in a water-in-salt electrolyte at 0.15 C.

FIG. 12C is a graph depicting the electrochemical performances LiMn₂O₄/Mo₃S₄ full cell in a water-in-salt electrolyte at 4.5 C.

FIG. 12D is a graph depicting the electrochemical performances employing a water-in-salt electrolyte in full cell configuration for the charge-discharge profile at high rate (4.5 C).

FIG. 13A is a graph showing the open circuit voltage change of a full-cell with times after fully charged to 2.3 V then relaxation.

FIG. 13B is a graph showing the energy density of three cells starting at different initial voltages.

FIG. 14 is a graph showing three performance indexes of full-cell configurations in aqueous lithium ion batteries reported in the literature.

FIG. 15 is X-ray photoelectron spectroscopy (XPS) spectrum of pristine Mo₃O₄ and full lithiation state.

FIG. 16A is a graph showing the molar ratio of salt to solvent and the corresponding hydration ion structure of various electrolytes.

FIG. 16B is a graph showing the relative activity coefficient calculated on the half-cell system with Mo₃S₄ as the anode and LiMn₂O₄ as the cathode.

FIG. 16C presents O¹⁷ NMR spectra for various electrolytes.

FIG. 16D presents Raman spectra showing the CF₃ bending vibration for various electrolytes.

FIGS. 17A is a schematic showing the molecular interactions of a solvent-in-water.

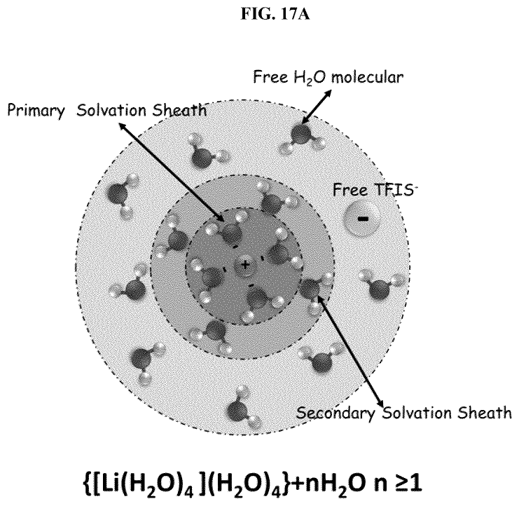

FIG. 17B is a schematic showing the molecular interactions of a water-in-solvent.

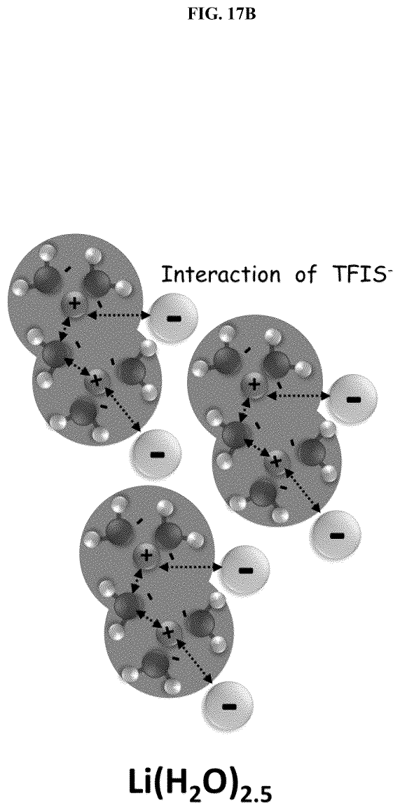

FIG. 18 is a diagram presenting voltage potentials for different electrolytes.

FIG. 19 is a cyclic voltammetry plot showing measurements of Mo₃S₄ in LiNO₃-H₂O with different molarity electrolytes (5 m, 10 m, and 12.5 m) at 0.1 mV/s.

FIG. 20 is a cyclic voltammetry plot showing measurements of Mo₃S₄ in statured Li₂SO₄-H₂O at 0.1 mV/s.

### DETAILED DESCRIPTION OF THE INVENTION

As used herein, the singular terms “a” and “the” are synonymous and used interchangeably with “one or more” and “at least one,” unless the language and/or context clearly indicates otherwise.

All numbers in this description indicating amounts, ratios of material, physical properties of materials and/or use are to be understood as modified by the word “about,” except otherwise explicitly indicated.

The term “about” is used herein to mean the given number plus or minus 1 to 10%.

As used herein, the term “cathode” refers to the electrode where electrochemical reduction occurs during the discharging process.

As used herein, the term “anode” refers to the electrode where electrochemical oxidation occurs during the discharging process.

As used herein, the term “nano” means that the particle size is less than 100 nm.

The Mg²⁺/H⁺ hybrid chemistry of the present invention comprises: a nano-M anode (wherein M is a metal or a metal alloy), an aqueous electrolyte based on a salt-saturated electrolyte or a “water-in-salt” electrolyte, and a metal cathode based on Mg_{0.5}AOOH (wherein A is a metal, a metal alloy, or a metal intercalation material).

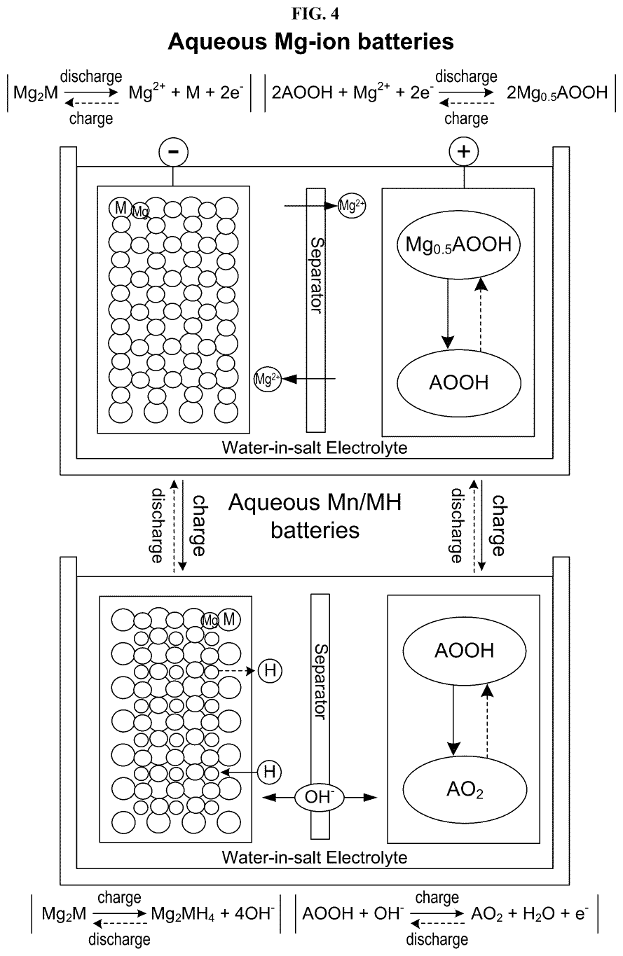

As shown in FIG. 4, during charge, initially Mg²⁺ ions move from the Mg_{0.5}AOOH positive electrode through the aqueous electrolyte to form an intermetallic alloy with the nano-M (the particle size is less than 100 nanometers) negative electrode, since these nano-M anodes can only electrochemically alloy with Mg but not with H. The formation of Mg₂M from M generates a high capacity (1816 mAh/g for Ni), while the Mg_{0.5}AOOH positive electrode will change to AOOH (capacity: 268 mAh/g for Mg_{0.5}AOOH). Due to the extra-low water activity of saturated electrolyte and “water-in-Mg-salt” electrolytes, Mg corrosion in Mg₂M will be effectively suppressed during this stage of insertion by Mg²⁺. The formed Mg₂M, a known hydrogen storage material and previously used as an alkaline Ni/MH battery negative electrode, will act as a host for the next stage of chemistry, i.e., absorption of H⁺, with an additional capacity (1001 mAh/g for Mg₂Ni to form Mg₂NiH₄). In this process, the AOOH will further oxidize into AO₂ giving additional capacity (308 mAh/g for MnO₂). The total theoretical capacities of the Ni anode and the Mg_{0.5}AOOH cathode are 2817 mAh/g and 576 mAh/g, respectively. Thus, with optimum anode/cathode matching this hybridized cell chemistry combining Mg⁺-insertion/H⁺-absorption can potentially provide 478 mAh/g on the full-cell level in the voltage range of 2.5 V, which is equivalent to an energy density of −1195 Wh/kg, higher than the theoretical capacity (390 Wh/kg) of C/LiCoO₂ battery by more than three times.

During discharge, a reverse reaction will take place (FIG. 4) due to the good reversibility. Thus, hybrid Mg²⁺/H⁺ aqueous chemistry is instrically hybridized on a materials level.

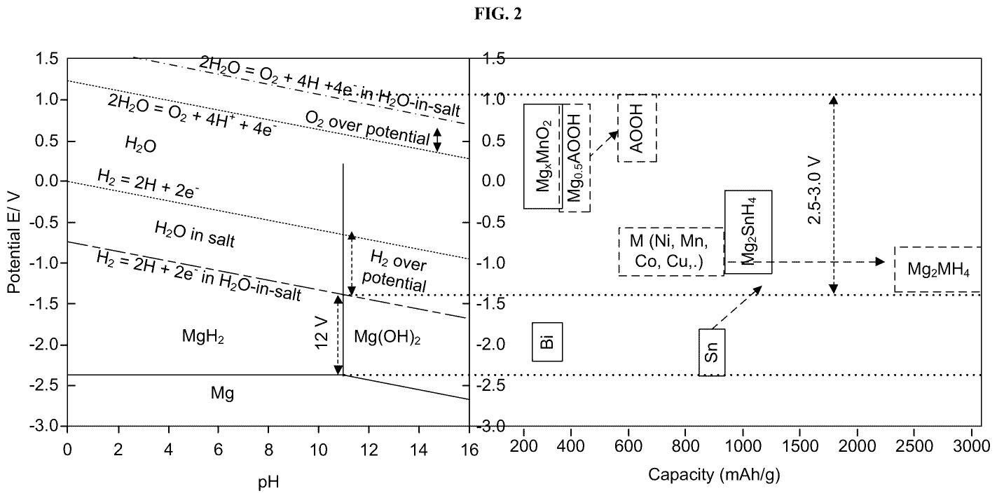

Innovative aspects of the hybrid Mg²⁺/H⁺ aqueous chemistry:
(1) Use of a salt saturated liquid electrolyte and “water-in-salt” solid electrolyte can effectively reduce the water activity, thus (a) increasing the cell energy density by enlarging the cell voltage (see FIG. 2); (b) improving the cycling life of batteries by preventing the corrosion of Mg₂M anodes in aqueous electrolyte; (c) protecting the cell from overcharge/discharge through water decomposition and recombination, as Ni/MH battery, and improve the safety; and (d) operating at a low temperature of −30° C. due to freezing temperature of saturated electrolyte (Yin, supra). Although the ionic conductivity of salt in “water-in-salt (LiSO₄-MgSO₄)” will be reduced from its maximum value to 0.1 S/cm due to the high concentration used, it is still more than 10 times higher than the typical ion conductivities (10 mS/cm) of organic electrolyte currently used in Li-ion batteries.
(2) Integration of aqueous Mg₂ into a Mn/MH battery on a materials level, thus (a) increasing the capacity of the Mn/MH cell by more than 3 times; and (b) preventing the oxidation of Mg₂MH₄ anodes by O₂ through a combination of hydrogen in Mg₂MH₄ improving cycling stability of batteries. In the presence of O₂ in an aqueous electrolyte cell, all negative electrode materials (except the MH electrode) would theoretically be subject to chemical oxidation by O₂ rather than undergo the electrochemical redox process (Wang, Y., et al., Adv. Energy Mater. 2:830-840 (2012)).

The serious intrinsic problem of an aqueous ion (Mg²⁺, Li⁺, Na⁺) battery using active metal anodes is that these metals tend to be chemically oxidized by the O₂ that is generated at the cathode during charge (if cathode capacity is lower than anode capacity) or overcharge. This parasitic reaction will quickly reduce the utilizable capacity of anodes (Luo, J. Y., et al., Nat. Chem. 2:760 (2010)). However, in Mg²⁺/H⁺ hybrid batteries, the absorbed H will be first oxidized rather than Mg in Mg₂MH₄ forming water, thus protecting Mg from corrosion. The electronic controlling circuit for preventing the overcharge used in organic electrolyte will thus be eliminated due to this shuttle protection mechanism.

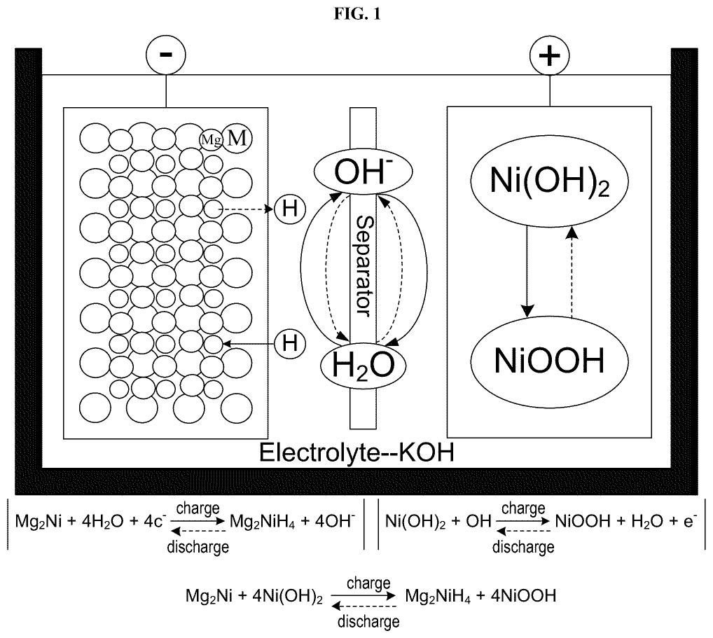

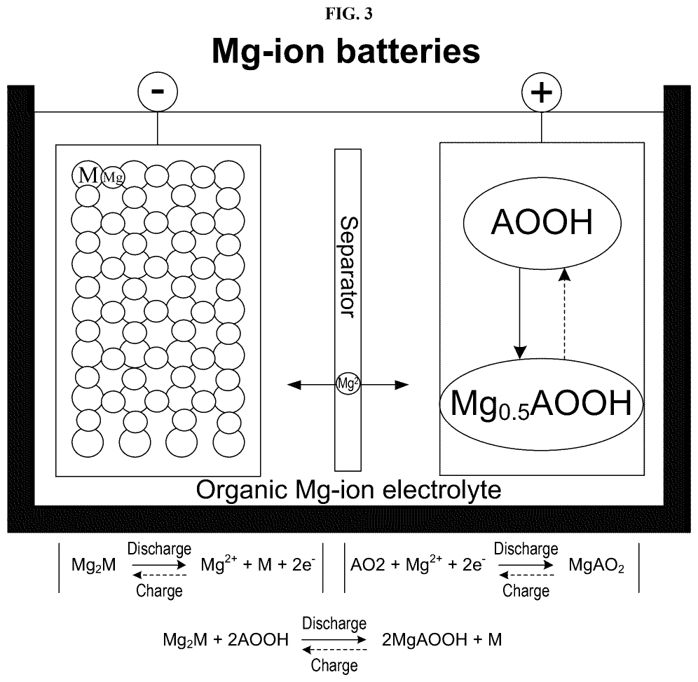

Therefore, the aqueous electrolyte battery (FIG. 4) hybridizes two distinct battery chemistries into an aqueous hybrid Mg²⁺/H⁺ battery system on a materials level, combining the high capacities of Ni/Mg₂NiH₄ (FIG. 1) and Mg-ion rechargeable chemistries (FIG. 3) while circumventing the disadvantages of both.
(3) The aqueous hybrid Mg-ion/H-ion battery will have (a) 2 times the energy density of current Li-ion batteries; (2) have more than 1000 cycle life at 80% depth of discharge (DOD); (3) be much cheaper due to aqueous electrolyte, abundant Mg metals used, and absence of battery management system; (4) have power density comparable to Li-ion batteries; (5) be intrinsically safe; and (6) operate in wide range of temperatures from −30° C. to +70° C. These performances cannot be reached by any existing battery chemistries, representing a fundamental advancement relative to the state of the art in the EV battery technologies.

In one embodiment, the disclosure provides an electrochemical cell comprising:
(a) an anode;
(b) a cathode comprising Mg_{0.05}AOOH, wherein A is a metal or an alloy of a metal; and
(c) an aqueous electrolyte.

In some embodiments, the electrochemical cell is a battery cell. In some embodiments, the electrochemical cell is a secondary battery cell.

### The Anode

Since the roles of M in MgₓM are reaction accelerator and corrosion resistor for hydriding/dehydriding, and a stabilizer for Mg-ion insertion/extraction in aqueous electrolyte, any metals and alloys that can electrochemically react with Mg-ion at a potential between 0.8-1.3V can be selected for H⁺ insertion/extraction in saturated liquid electrolyte or water-in-salt solid electrolyte.

In some embodiments, anode materials are selected that have theoretical potential between 0.8-1.3 V vs. Mg and high capacity. The anode materials can be designed in nano-size to accelerate the kinetics for Mg-ion insertion/extraction. The Mg-ion insertion/extraction potential of anode materials can be compared and their capacity measured in organic electrolyte and evaluated against theoretical values. The diffusion coefficient of Mg-ion in nano-M can be determined using phase transformation, a galvanostatic intermittent titration technique (GITT), a potentiostatic intermittent titration technique (PITT), and/or constant voltage (CV) measurements (see Zhu, Y., et al., J. Phys. Chem. C 115:823-832 (2011) and Zhu, Y., J. Phys. Chem. C 114:2830-2841 (2010)). One of ordinary skill in the art can select nano-M anodes based on cycling stability tests. And, one of ordinary skill in the art can determine the structure and morphology of anode materials using scanning electrode microscopy (SEM), transmission electrode microscopy (TEM), and/or x-ray diffraction spectroscopy (XRD).

In some embodiments, the anode material is a nano-M (wherein M is a metal or a metal alloy). In some embodiments, M is selected from the group consisting of Li, Mg, Mn, Co, Ti, Zn, Al, Zn, Cr, Fe, Ni, Sn, Pb, H, Cu, Ag, Pd, Hg, Pt, Bi, Zr, and Au. In some embodiments, M is an alloy of a metal selected from the group consisting of Li, Mg, Mn, Co, Ti, Zn, Al, Zn, Cr, Fe, Ni, Sn, Pb, H, Cu, Ag, Pd, Hg, Pt, Bi, Zr, and Au.

In some embodiments, the anode material is Mg₂M (wherein M is a metal or a metal alloy). In some embodiments, M is selected from the group consisting of Li, Mg, Mn, Co, Ti, Zn, Al, Zn, Cr, Fe, Ni, Sn, Pb, H, Cu, Ag, Pd, Hg, Pt, Bi, Zr, and Au. In some embodiments, M is an alloy of a metal selected from the group consisting of Li, Mg, Mn, Co, Ti, Zn, Al, Zn, Cr, Fe, Ni, Sn, Pb, H, Cu, Ag, Pd, Hg, Pt, Bi, Zr, and Au. In some embodiments, the anode material is Mg₂Ni.

In some embodiments, the anode material is Mo₃S₄.

Anode materials can be screened using an organic Mg-ion conductive electrolyte. In some embodiments, the conductive electrolyte is a boron-based Mg-ion conductive electrolyte with an electrochemical window of >3.5 V (see Guo, Y.-S., et al., Energy Environ. Sci. 5:9100-9106 (2012)).

A boron-based Mg-ion conductive electrolyte consists of the reaction products between tri(3,5-dimethylphenyl)borane and PhMgCl in THF. The electrolyte shows a very high magnesium reversibility and deposition/dissolution efficiency of almost 100%. The wide electrochemical window from 0.0-3.5 V can accurately measure the potential and capacity of a cathode without the influence of side reactions.

### The Cathode

The cathode materials can be synthesized using hydrothermal and electrochemical methods known to those of skill in the art. The electrochemical performance of the cathode materials during Mg-ion insertion/extraction in organic electrolyte and electrochemical performance of Mg-ion extracted AOOH during proton insertion/extraction in Mg-free saturated aqueous electrolyte and water-in-salt electrolyte can be tested using techniques known to those in the art. And, the performance of cathode materials during hybrid Mg²⁺ can be analyzed using techniques known to those in the art.

A boron-based Mg-ion conductive electrolyte consists of the reaction products between tri(3,5-dimethylphenyl)borane and PhMgCl in THF. The electrolyte shows a very high magnesium reversibility and deposition/dissolution efficiency of almost 100%. The wide electrochemical window from 0.0-3.5 V can accurately measure the potential and capacity of a cathode without the influence of side reactions.

Some metal oxides and sulfides react with the Mg-ion at a high potential. In some embodiments, the cathode is a Mg-ion battery cathode material. In some embodiments, the Mg-ion battery cathode material is a Chevrel phase MxMo3T4 (M=metal, T=S or Se), a vanadium oxide, a TiS₂ nanotube, mesoporous Mg_{1.03}Mn_{0.97}SiO₄, or a graphite-like MoS₂.

In some embodiments, the cathode material is Mg_{0.5}AOOH (wherein A is a metal or a metal alloy). In some embodiments, A is a metal selected from the group consisting of Li, Mg, Mn, Co, Ti, Zn, Al, Zn, Cr, Fe, Ni, Sn, Pb, H, Cu, Ag, Pd, Hg, Pt, Bi, Zr, and Au. In some embodiments, A is an alloy of a metal selected from the group consisting of Li, Mg, Mn, Co, Ti, Zn, Al, Zn, Cr, Fe, Ni, Sn, Pb, H, Cu, Ag, Pd, Hg, Pt, Bi, Zr, and Au. In some embodiments, the cathode material is Mg_{0.5}MnOOH. In some embodiments, the cathode material is Mg_{0.5}CoOOH, Mg_{0.5}NiOOH, or Mg_{0.5}FeOOH.

In some embodiments, the cathode material is LiMn₂O₄.

Cathode materials can be screened using an organic Mg-ion conductive electrolyte. In some embodiments, the conductive electrolyte is a boron-based Mg-ion conductive electrolyte with an electrochemical window of >3.5 V (see Guo, supra).

In some embodiments, the cathode materials are synthesized using hydrothermal and electrochemical methods that are known to those skilled in the art. For example, MnOOH can be synthesized using a one-step hydrothermal method (He, L., et al., Journal of Power Sources 220:e228-e235 (2012)). Mg_{0.5}MnOOH can be synthesized using a electrochemical method (Mg-ion insertion) or using a hydrothermal method (adding MgSO₄ in a precursor).

### High Voltage Aqueous Electrolyte

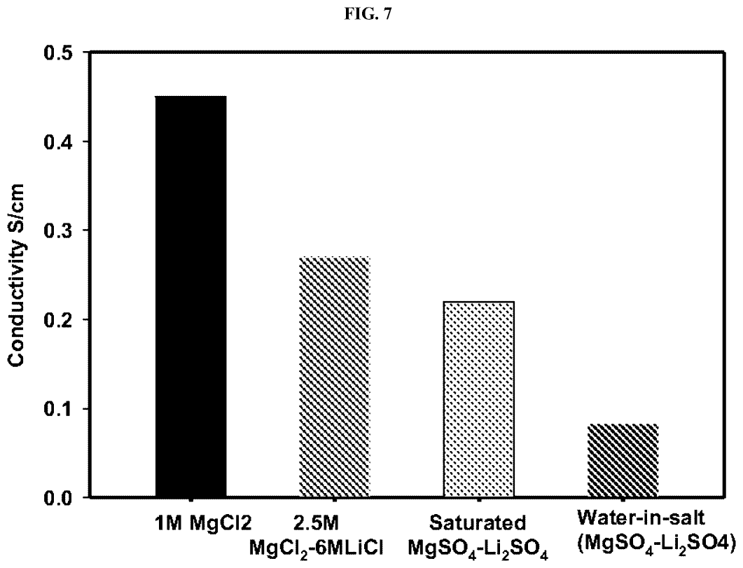

The theoretical energy density of the hybridized Mg²⁺/H⁺ chemistry in aqueous electrolytes is about 2 times higher than the theoretical energy density of non-aqueous LiCoO₂/graphite Li-ion batteries. Although the high concentration of salt in the water-in-salt reduces the ionic conductivity (about 0.1 S/cm (see FIG. 7)), it is still about 10-20 times higher than that of an organic electrolyte (about 5-10 mS/cm). Therefore, the hybrid cell should also support power density comparable to that of Li-ion batteries. Moreover, the use of a water-in-salt electrolyte can mitigate the corrosion of magnesium alloys, a major reason for capacity decline of Mg-based metal hydride anodes in Ni/MH batteries and thus enhance the cycling life of the hybrid cells. Furthermore, the chemical oxidation of Mg in Mg₂M anodes in the presence of O₂ will be prevented in the hybridized Mg²⁺/H⁺ chemistry by oxidation of the proton in Mg₂MH₄ to form water and further improve cycling life.

The thermal runway hazard can be essentially eliminated with the use of an aqueous electrolyte. The shuttle reaction through water electrolysis and recombination protects the hybridized Mg²⁺/H⁺ ion cell from overcharge and discharge, further improving the safety. The aqueous electrolyte is also much cheaper than non-aqueous electrolytes not only due to the abundance of Mg but also due to the absence of organic solvents. Furthermore, the use of Mg-based anodes (i.e., Mg₂Ni: 1001 mAh/g) to replace LaNi₅H₆ (371 mAh/g) alloys enhances the cell capacity and reduces the cost per energy density.

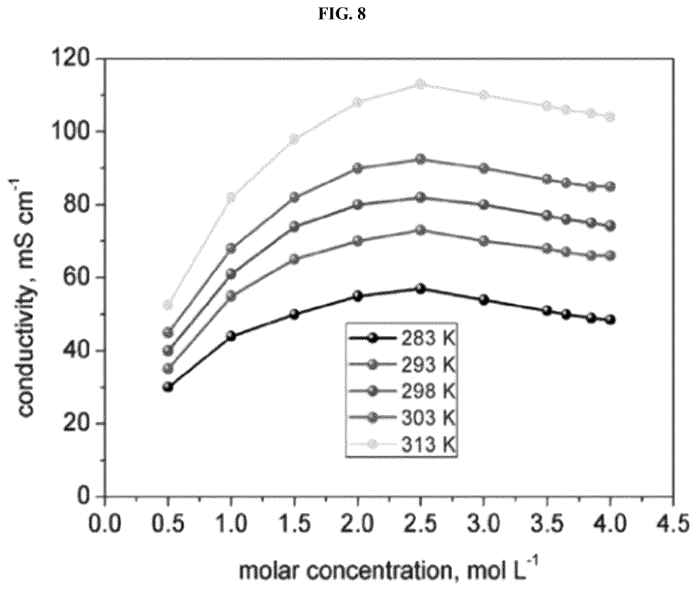

In aqueous electrolytes, some water molecules bond with metal cations and inorganic anions generated by disassociation of salts. Among K⁺, Na⁺, and Li⁺ cations, Li⁺ has highest water solvation capability. Li⁺ can bond with 27 water molecules (see Fic, supra), which significantly reduces the water activity, thus increasing the overpotential for H₂ and O₂ evolution. Among anions, SO₄²⁻ is one of the strongest solvated inorganic anions with 40 water molecules bonded. The electrochemical stability window of 1 M Li₂SO₄ electrolyte can reach 2.2 V (see Fic, supra). It is expected that if salt concentration reaches saturation, almost all water molecules are bonded to the anion and cation, and water activity for decomposition into H₂ and O₂ will be minimized. As shown in FIG. 7, the electrochemical stability window of a saturated Li₂SO₄-MgSO₄ (_{1:1}) electrolyte is 2.5 V. Despite the suppressed water activity, the ionic conductivity of Li₂SO₄ electrolytes do not suffer too much as the interested salt concentration. FIG. 8 shows the conductivity of a Li₂SO₄ electrolyte at different concentration and temperatures, in which a saturated Li₂SO₄-MgSO₄ electrolyte still provides 0.22 S/cm at room temperature, about 20-40 times higher than nonaqueous electrolytes.

In some embodiments, the aqueous electrolyte is a water-in-salt electrolyte. As used herein, the term “water-in-salt” means that the weight ratio of salt to solvent or volume ratio of salt to solvent exceed 1.0. In some embodiments, the weight or volume of salt is more than solvent.

In some embodiments, the molar ratio of salt to water in the water-in-salt electrolyte is between 0.5:1 and 200:1, between 0.5:1 and 150:1, between 0.5:1 and 100:1, between 0.5:1and 50:1, between 0.5:1 and 10:1, between 0.5:1 and 5:1, between 0.5:1 and 1:1, between 0.8:1and 200:1, between 0.8:1 and 150:1, between 0.8:1 and 100:1, between 0.8:1 and 50:1, between 0.8:1 and 10:1, between 0.8:1 and 5:1, between 0.8:1 and 1:1, between 1:1 and 200:1, between 1:1 and 150:1, between 1:1 and 100:1, between 1:1 and 50:1, between 1:1 and 10:1, or between 1:1 and 5:1.

In some embodiments, the weight percentage of salt in the water-in-salt electrolyte (wherein the weight percentage of the salt=((weight of salt/(weight of salt+weight of water)) ×100) is between 5% and 90%, between 10% and 90%, between 20% and 90%, between 30% and 90%, between 40% and 90%, between 50% and 90%, between 60% and 90%, between 70% and 90%, between 80% and 90%, between 5% and 80%, between 10% and 80%, between 20% and 80%, between 30% and 80%, between 40% and 80%, between 50% and 80%, between 60% and 80%, between 70% and 80%, between 5% and 70%, between 10% and 70%, between 20% and 70%, between 30% and 70%, between 40% and 70%, between 50% and 70%, between 60% and 70%, between 5% and 60%, between 10% and 60%, between 20% and 60%, between 30% and 60%, between 40% and 60%, between 50% and 60%, between 5% and 50%, between 10% and 50%, between 20% and 50%, between 30% and 50%, between 40% and 50%, between 5% and 40%, between 10% and 40%, between 20% and 40%, between 20% and 30%, between 5% and 30%, between 10% and 30%, between 20% and 30%, between 5% and 20%, between 10% and 20%, or between 5% and 10%.

In some embodiments, the water-in-salt electrolyte is a sulfone-based electrolyte such as LiN(SO₂CF₃)₂ (LiTFSI), LiN(SO₂CH₃)₂, LiN(SO₂C₄H₉)₂, LiN(SO₂C₂F₅)₂ (LiBETI), LiN(SO₂C₄F₉)₂, LiN(SO₂F₃)(SO₂C₄F₉), LiN(SO₂C₂F₅)(SO₂C₄F₉), LiN(SO₂C₂F₄SO₂), LiN(SO₂F)₂ (LiFSI), or LiN(SO₂F)(SO₂CF₃) (LiFTI). In some embodiments, the aqueous electrolyte is LiN(SO₂CF₃)₂.

In some embodiments, the aqueous electrolyte is LiPF₆ or LiSO₃CF₃.

In some embodiments, the aqueous electrolyte is a water-in-Mg-salt electrolyte. In some embodiments, the water-in-Mg-salt electrolyte is LiSO₄-MgSO₄, LiCl-MgCl₂, or Li(NO₃)-Mg(NO₃)₂.

In some embodiments, the aqueous electrolyte is a high voltage aqueous electrolyte.

In some embodiments, the aqueous electrolyte contains a significant amount of water (i.e., not merely a trace amount), and the electrolyte is disposed in the cell such that it directly contacts the cathode. In certain embodiments water serves as the main liquid solvent of the electrolyte. In some embodiments, water is the only electrolyte solvent.

In some embodiments, a significant (non-trace) amount of water is incorporated in the electrolyte. In some embodiments the volume percent of water in the electrolyte relative to the total liquid solvent volume is greater than 5%, 10%, 20%, 30%, 40%, 50%, 60%, 70%, 80%, or 90%. In some embodiments water is the only liquid solvent in the electrolyte (i.e., water constitutes 100% of the solvent volume of the electrolyte). In some embodiments water is the main solvent in the electrolyte. In some embodiments, the volume percent of water in the electrolyte is between 5% and 90%, between 10% and 90%, between 20% and 90%, between 30% and 90%, between 40% and 90%, between 50% and 90%, between 60% and 90%, between 70% and 90%, between 80% and 90%, between 5% and 80%, between 10% and 80%, between 20% and 80%, between 30% and 80%, between 40% and 80%, between 50% and 80%, between 60% and 80%, between 70% and 80%, between 5% and 70%, between 10% and 70%, between 20% and 70%, between 30% and 70%, between 40% and 70%, between 50% and 70%, between 60% and 70%, between 5% and 60%, between 10% and 60%, between 20% and 60%, between 30% and 60%, between 40% and 60%, between 50% and 60%, between 5% and 50%, between 10% and 50%, between 20% and 50%, between 30% and 50%, between 40% and 50%, between 5% and 40%, between 10% and 40%, between 20% and 40%, between 20% and 30%, between 5% and 30%, between 10% and 30%, between 20% and 30%, between 5% and 20%, between 10% and 20%, or between 5% and 10%.

In some embodiments, the pH of the aqueous electrolyte solution is between 7 and 11. In some embodiments, the pH of the aqueous electrolyte solution is greater than 6, 7, 8, 9, 10, 11, 12, or 13. In some embodiments, the pH of the aqueous electrolyte solution is between 5 and 14, between 5 and 13, between 5 and 12, between 5 and 11, between 5 and 10, between 5 and 9, between 5 and 8, between 6 and 14, between 6 and 13, between 6 and 12, between 6 and 11, between 6 and 10, between 6 and 9, between 6 and 8, between 7 and 14, between 7 and 13, between 7 and 12, between 7 and 11, between 7 and 10, between 7 and 9, between 7 and 8, between 8 and 14, between 8 and 13, between 8 and 12, between 8 and 11, between 8 and 10, or between 8 and 9. In some embodiments, the pH can be tailored using pH adjusting additives including basic salts, acidic salts, and buffering agents. In some embodiments, the pH is adjusted using LiOH.

In some embodiments, the electrolyte is formulated to have a pH that is acidic (pH<7), basic (pH>7), or neutral (pH about 7).

In some embodiments, the aqueous electrolyte further comprises one or more non-aqueous solvents. In some embodiments, the volume percent of non-aqueous solvents in the electrolyte ranges is between 1% and 10%, between 10% and 20%, between 20% and 30%, between 30% and 40%, between 40% and 50%, between 50% and 60%, between 60% and 70%, between 70% and 80%, or between 80% and 90%.

In some embodiments, the anode and cathode cell contain the same electrolyte. In some embodiments, the anode and cathode cell contain different electrolytes.

In some embodiments, the non-aqueous solvent is a aprotic, protic organic solvents (solids and liquids, typically liquids or solid polyethylene oxide), or ionic liquid. In some embodiments, the non-aqueous solvent is a protic organic solvents.

In some embodiments, suitable non-aqueous aprotic and protic solvents include ethers (e.g., 2-Methyltetrahydrofuran (2-MeTHF), Tetrahydrofuran (THF), 4-Methyldioxolane (4-MeDIOX), Tetrahydropyran (THP) and 1,3-Dioxolane (DIOX)) glymes (e.g., 1,2-dimethoxyethane (DME/mono-glyme), di-glyme, tri-glyme, tetra-glyme and higher glymes), carbonates (e.g., cyclic carbonates such as propylene carbonate (PC), ethylene carbonate (EC), acyclic carbonates such as dimethyl carbonate (DMC), ethylmethyl carbonate (EMC) and diethyl carbonate (DEC), formates (e.g., Methyl Formate) and butyrolactone (GBL). Other suitable aprotic solvents include those having a high donor number (i.e., donor solvents) such as hexamethylphosphoramide, pyridine, N,N-diethylacetamide (DMAC), N,N-diethylformamide, dimethylsulfoxide (DMSO), tetramethylurea (TMU), N,N-dimethylacetamide, N,N-dimethylformamide (DMF), tributylphosphate, trimethylphosphate, N,N,N′,N′-tetraethylsulfamide, tetraethylenediamine, tetramethylpropylenediamine, and pentamethyldiethylenetriamine. In some embodiments, the donor solvents have a donor number of at least 15, between about 15 and 40, or between about 18-40. In some embodiments, donor solvents include N,N-diethylformamide, N,N-dimethylformamide (DMF), dimethylsulfoxide (DMSO), N,N-dimethylacetamide (DMAC); for example, DMF. Suitable acceptor solvents which can be characterized as Lewis acids (they may be protic or aprotic solvents) and promote solvation of anions. Examples include alcohols such as methanol, glycols such as ethylene glycol and polyglycols such as polyethylene glycol as well as nitromethane, triflouroacetic acide, trifluoromethanesulfonic acid, sulfur dioxide and boron triflouride, and ethylene glycol (EG). Others include nitriles (e.g., acetonitrile (AN), higher nitriles, propionitrile, succinonitrile, butyronitrile, benzonitrile), amides (e.g., formamide, N-methylformamide, N,N-dimethylformamide, N,N-diethylformamide, (DMF), acetamide, N-methylacetamide, N,N-dimethylacetamide (DMAC), N,N-diethylacetamide, N,N,N′N′tetraethylsulfamide, tetramethylurea (TMU), 2-pyrrolidone, N-methylpyrrolidone, N-methylpyrrolidinone), amines (e.g., butylamine, ehtylenediamine, triethylamine, pyridine, 1,1,3,3-tetramethylguanidine (TMG), tetraethylenediamine, tetramethylpropylenediamine, pentamethyldiethylenetriamine, organosulfur solvents (e.g., dimethylsulfoxide (DMSO), sulfolane, other sulfones, dimethylsulfite, ethylene sulfite, and organophosphorous solvents (e.g., tributylphosphate, trimethylphosphate, hexamethylphosphoramide (HMPA)).

In some embodiments, a non-aqueous solvent may be added to the aqueous electrolyte to affect dissolution. In some embodiments, the solvent is toluene or carbon disulfide.

The use of non-aqueous solvents such as aprotic organic solvents, typically liquids, is not limited as such, and may be useful for facilitating the dissolution of high order polysulfide species. Protic solvents and ionic liquids may also be incorporated in the aqueous electrolyte to further enhance dissolution of lithium sulfide or more generally improve cell performance.

In some embodiments, the electrolyte is formulated with an amount of a non-aqueous protic solvent to achieve a desired freezing point temperature (i.e., a melt temperature). In some embodiments, the electrolyte is formulated to have a melt temperature of less than 0° C., less than −5° C., less than −10° C., less than −15° C., less than −20° C., less than −25° C., less than −30° C., less than −35° C., or less than −40° C.

In some embodiments, the electrochemical cell operates at a temperature of less than about 100° C., less than about 90° C., less than about 80° C., less than about 70° C., less than about 60° C., less than about 50° C., less than about 40° C., less than about 30° C., less than about 20° C., or less than about 10° C. In some embodiments, the electrochemical cell operates at a temperature between −40° C. and 100° C., between −40° C. and 90° C., between −40° C. and 80° C., between −40° C. and 70° C., between −40° C. and 60° C., between −40° C. and 50° C., between −40° C. and 40° C., between −40° C. and 30° C., between −30° C. and 100° C., between 31 30° C. and 90° C., between −30° C. and 80° C., between −30° C. and 70° C., between −30° C. and 60° C., between −30° C. and 50° C., between −30° C. and 40° C., between −30° C. and 30° C., between −20° C. and 100° C., between −20° C. and 90°° C., between −20° C. and 80° C., between −20° C. and 70° C., between −20° C. and 60° C., between −20° C. and 50° C., between −20° C. and 40° C., or between −20° C. and 30° C.

In some embodiments, the electrochemical cell has a full cell output voltage greater than 1.5 V, greater than 1.6 V, greater than 1.7 V, greater than 1.8 V, greater than 1.9 V, or greater than 2.0 V. In some embodiments, the electrochemical cell has a fuel cell output voltage between 1.0 V and 4.0 V, between 1.0 V and 3.5 V, between 1.0 V and 3.0 V, between 1.0 V and 2.5 V, between 1.0 V and 2.0 V, between 1.0 V and 1.5 V, between 1.5 V and 4.0 V, between 1.5 V and 3.5 V, between 1.5 V and 3.0 V, between 1.5 V and 2.5 V, between 1.5 V and 2.0 V, between 2.0 V and 4.0 V, between 2.0 V and 3.5 V, between 2.0 V and 3.0 V, between 2.0 V and 2.5 V, between 2.5 V and 4.0 V, between 2.5 V and 3.5 V, or between 2.5V and 3.0 V.

In another embodiment, the disclosure provides an aqueous electrolyte battery comprising:
(a) an anode;
(b) comprising Mg_{0.05}AOOH, wherein A is a metal or an alloy of a metal; and
(c) an aqueous electrolyte.

In some embodiments, the aqueous electrolyte battery includes a separator between the positive electrode and the negative electrode. In some embodiments, the separator is subjected to hydrophilic treatment or perforated such that the separator can be permeated with an aqueous electrolyte solution, allowing ions to pass through the separator. The separator may be any separator that is commonly used in batteries. Examples of the separator include polymer nonwoven fabrics, such as polypropylene nonwoven fabric and poly(phenylene sulfide) nonwoven fabric, and macroporous membranes of olefin resins, such as polyethylene and polypropylene. These can be used alone or in combination.

The present invention also provides methods of manufacture of the aqueous electrolyte battery. In some embodiments, the method involves de-oxygenating the electrolyte and forming and sealing the cell in an inert or reducing environment devoid of molecular oxygen (e.g., a nitrogen environment) in order to reduce or eliminate free oxygen in the electrolyte solution. In this way the irreversible oxidation in the aqueous electrolyte and the resultant loss of material, is avoided.

In some embodiments, the cells are self-contained and sealed in a hermetic casing wherein the entirety of the cell is derived from and disposed in the casing during cell manufacture. These fully sealed cells may be secondary cells. In some embodiments, the casing comprises one layer. In some embodiments, the casing comprises more than one layer. In some embodiments, the casing comprises at least one layer selected from a polyethylene terephthalate layer, a polymer layer, and a propylene layer. In some embodiments, the casing comprises at least one carbonized plastic layer.

In some embodiments, the cells are configured in a battery flow cell system, wherein the aqueous electrolyte is caused to flow and/or circulate into the cell. In some embodiments, the aqueous electrolyte is caused to flow and/or circulate through an inter-electrode region between the anode and the cathode. In some embodiments, the electrolyte in the anode and the cathode are the same. In some embodiments, the electrolyte in the anode and the cathode are different. In some embodiments, the electrolyte in the anode and the cathode are flowable and during operation are caused to flow through the cell.

An aqueous electrolyte battery according to the present invention may be of any shape, such as coin-shaped, button-shaped, sheet-shaped, layered, cylindrical, flat, or square. An aqueous secondary battery according to the present invention may be applied to large objects, such as electric vehicles.

In some embodiments, the aqueous electrolyte battery is a secondary battery.

The following examples are illustrative and non-limiting of the electrochemical cells, methods of making, and methods of using described herein. Suitable modifications and adaptations of the variety of conditions, formulations and other parameters normally encountered in the field and which are obvious to those skilled in the art in view of this disclosure are within the spirit and scope of the invention.

### EXAMPLES

### Example 1

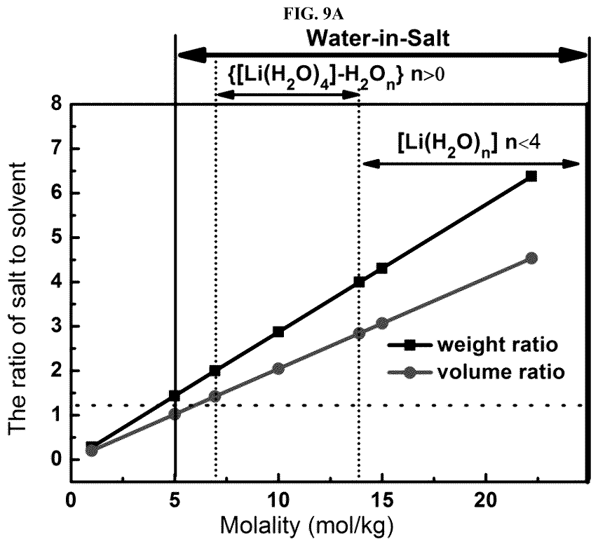

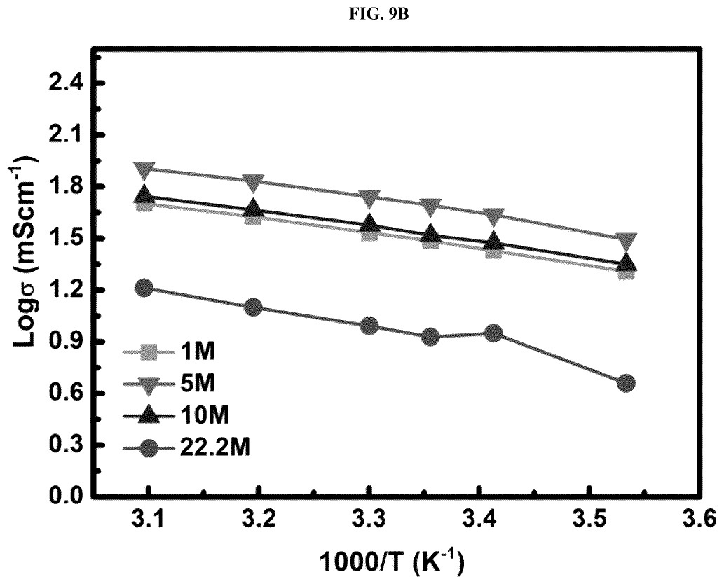

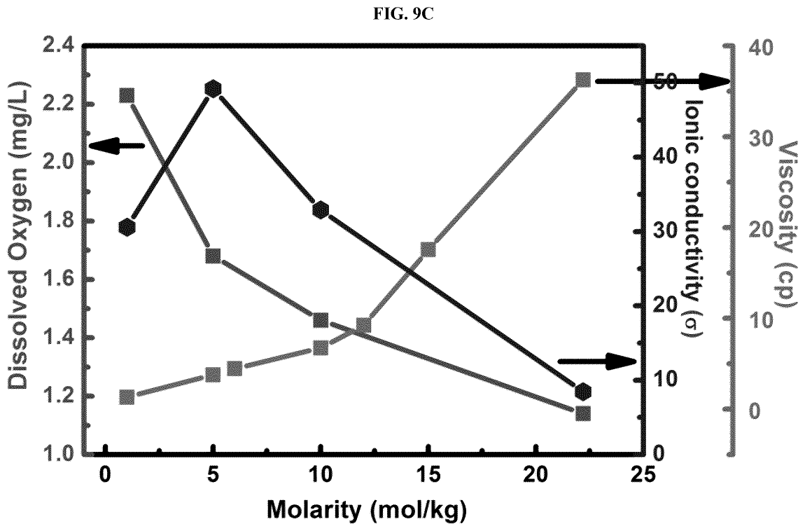

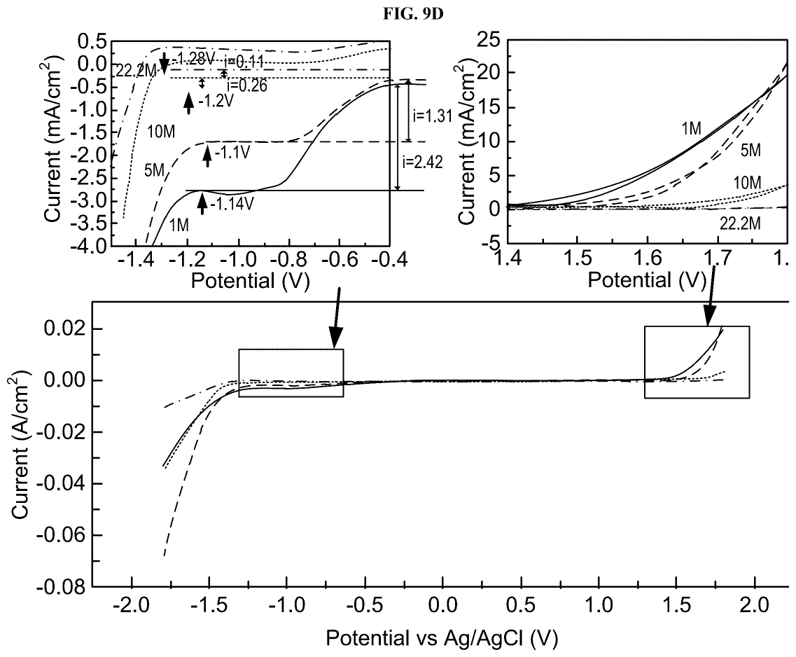

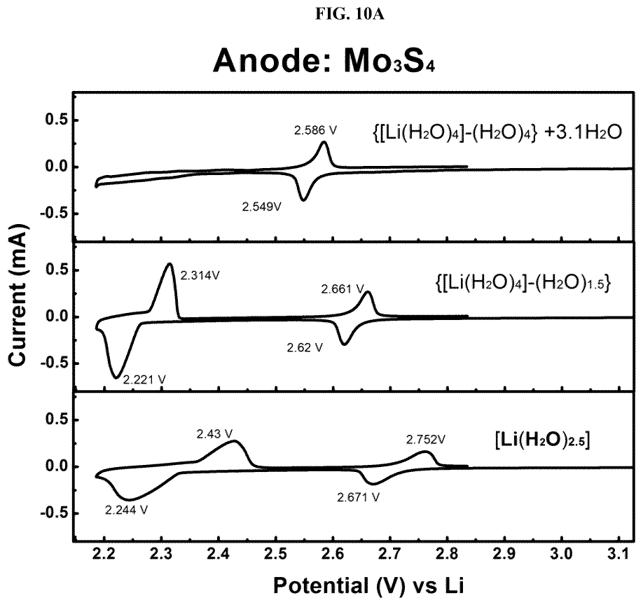

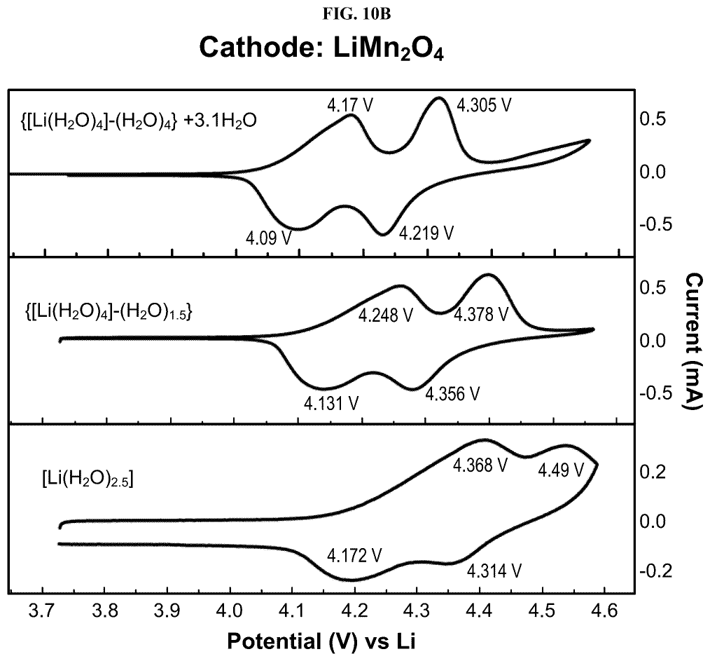

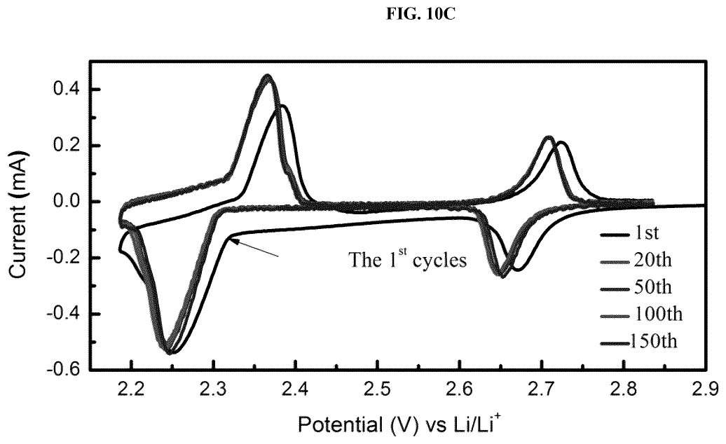

The physicochemical and electrochemical properties of different ratio of LiN(SO₂CF₃)₂ (LiTFSI) to H₂O are shown in FIGS. 9A-D. Based on the ratio of salt to solvent by weigh and volume in a binary electrolyte system (FIG. 9A), when the molality increases to 5 mol/kg, the weight ratio of salt to solvent exceeds 1.0. From this point, the system can be defined as “water-in-salt,” which could also be considered liquid water is dissolved into solid LiTFSI. In this case, the physicochemical and electrochemical properties will go through a fundamental change, due to the variation of interaction between cation and water (the structure and dynamic of hydration ion), cation and anion (lattice energy) and so on. The variation of ionic conductivity as a function of temperature for different ratios of LiTFSI to H₂O is shown in FIG. 10B. As shown in FIG. 9B, an ionic conductivity of 22.2 m slight shows a slight decrease due to high viscosity compared to lower molality ratios. Nevertheless, the conductivity of the 22.2 m sample at 25° C. shows an ionic conductivity of 8 mS/cm which is close to that of a commercial lithium ion organic electrolyte (FIG. 9C). The variation of dissolved oxygen content at room temperature tends to decrease monotonically with increasing LiTFSI content in the LiTFSI-H₂O binary composition (FIG. 9C). In general, the solubility of dissolved oxygen in water is affected significantly by the presence of other solutes in the solution. When LiTFSI is dissolved in water, the cations (Li⁺) attract water molecules, which has the tendency to decrease the weak affinity of non-polar oxygen molecules to water and drive the dissolved oxygen out of the polar water. The stable electrochemical window is presented in FIG. 9D. FIG. 9D shows that the oxygen and hydrogen evolution potential are expanded significantly by adjusting the ratio of LiTFSI to Water. For the 22.2 m sample, both the amount of hydrogen and oxygen evolution per unit current collector area is suppressed significantly beyond the range of water window. Meanwhile, the enlarged graph of the anodic potential shows that anodic current of all the electrolytes occur at −0.4 V vs Ag/AgCl reference, however, with the decreasing of scanning potential, anodic current does not continues to increase but remains stable at a fixed value in a certain range, and the anodic current decreases an order of magnitude from 2.41 uA/cm² (5 m) to 0.11 uA/cm² (22.2 m) and there is a noticeable increase in current starting at −1.3 V vs Ag/AgCl corresponding to hydrogen evolution potential.

### Example 2

The Nernst equation relates the chemical reaction energy to electrolyte energy:

$$E = {E}^{0} + \frac{kT}{q} lnQ$$

wherein:
E=energy at a given concentration
E⁰=energy at standard 1 molar concentration
Q=molar concentration
kT/q=26 mV at 298° K

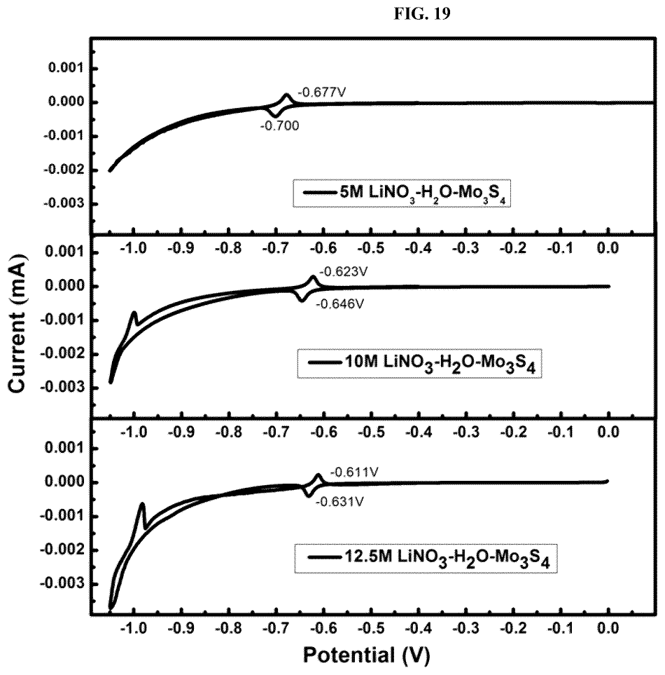

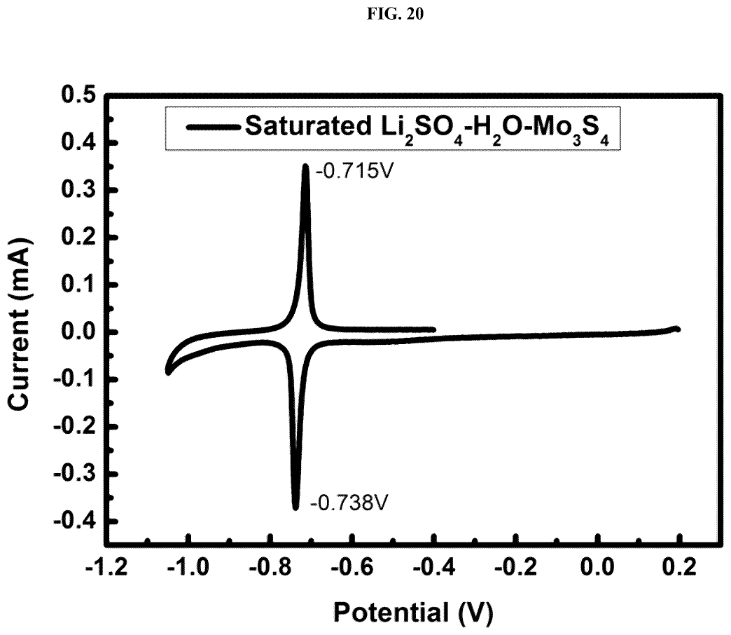

Based on the Nernst equation, the potential of an electrode in a half-cell is determined by lithium ion activity in the electrolyte. In order to capture this trend, absolute electrode potentials in different ratios of LiTFSI to H₂O were recorded in three electrode systems using cyclic voltammetry (CV) (FIG. 10 (LiMn₂O₄) and 10A (Mo₃S₄)). FIGS. 10A and 10B show that both LiMn₂O₄ and Mo₃S₄ absolute electrode potentials are evidently increased by the increased ratio of salt to solvent, and this absolute electrode potential adjustment neither influences the full-cell output voltage nor makes the anode potential move into the electrolyte window. As control experiments, traditional aqueous electrolytes with different LiNO₃ concentrations and saturated Li₂SO₄ (<3 m) were also tested (FIGS. 19 and 20). As seen in FIGS. 19 and 20, with increasing salt concentration, the electrode absolute potential shifted into high voltage; however, due to the limitation of the inorganic lithium salt's solubility in water, the variation was confined to a small amplitude. In addition, hydrogen evolution took place apparently in the low potential range (<0.8 V vs Ag/AgCl), even at the highest LiNO₃ concentration (12.5 M)—close to saturation.

### Example 3

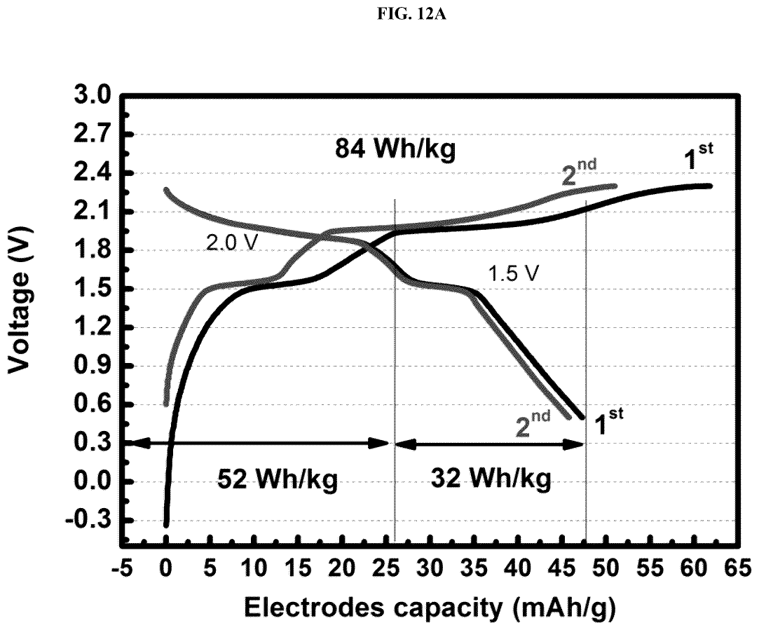

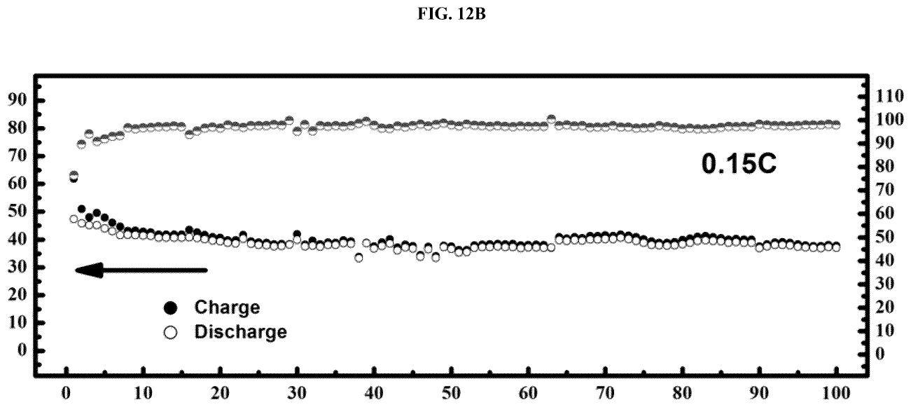

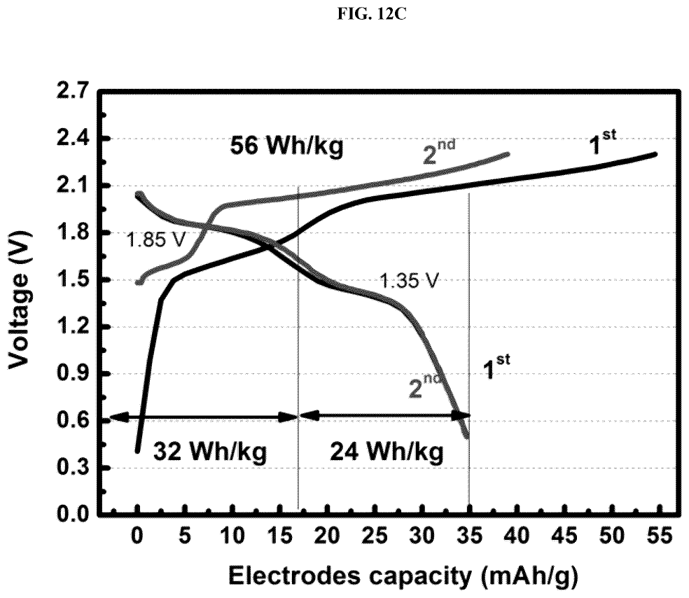

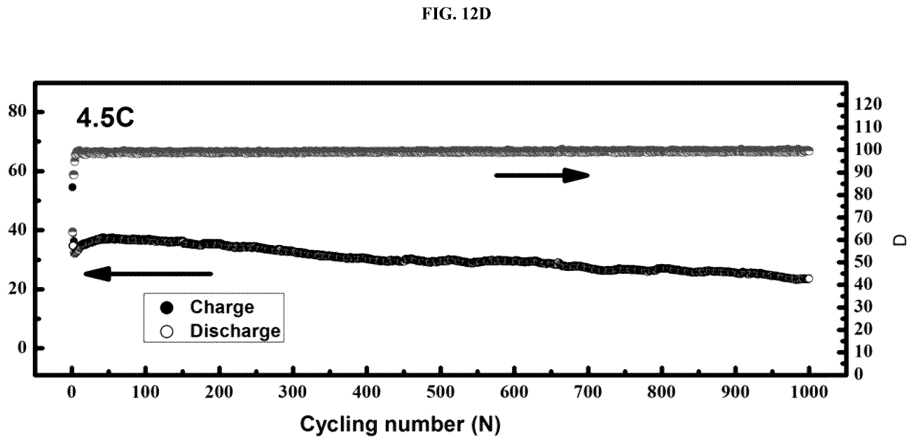

To further evaluate the effect of the water-in-salt electrolyte, a full-cell configuration was employed with LiMn₂O₄ as cathode and Mo₃S₄ as anode (FIG. 12A and 12B). Due to the anode irreversibly capacity in the first cycles, the mass ratio of the cathode to the anode in the full-cell was set up about 2:1.

As shown in FIG. 12A and 12C, the full-cell presents two discharge/charge plateaus and average voltage outputs are 1.5 and 2.0 V, respectively. The discharge capacity of the full-cell was achieved at 47 mAh/g calculated using the total electrode weight. Therefore, based on this data, we can roughly estimate that, in this full-cell configuration, the energy density is close to nearly 84 Wh/kg. It is noteworthy that the cycling life of the full-cell is very stable not only at high rate (4.5 C) but also at low rate (0.15 C) which is in striking contrast to previous findings accelerating the charge-discharge rate to prolong cycling life.

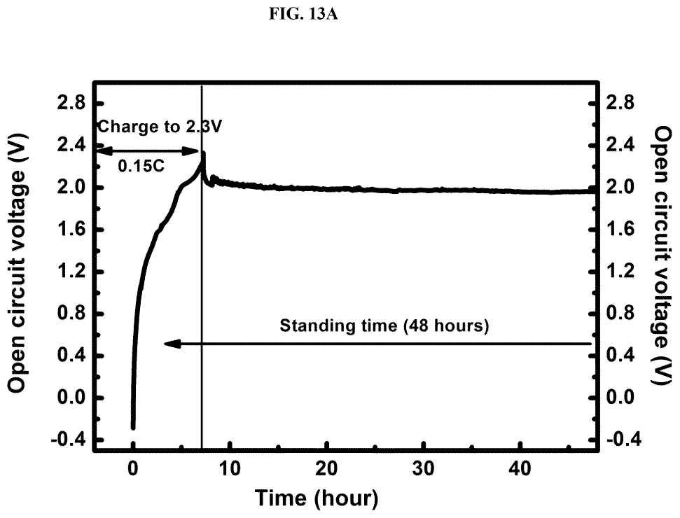

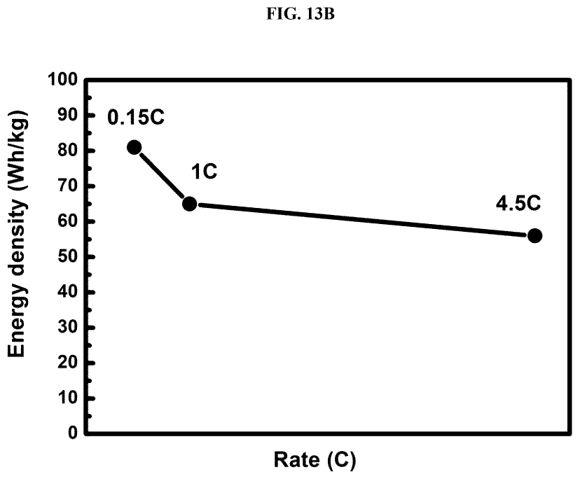

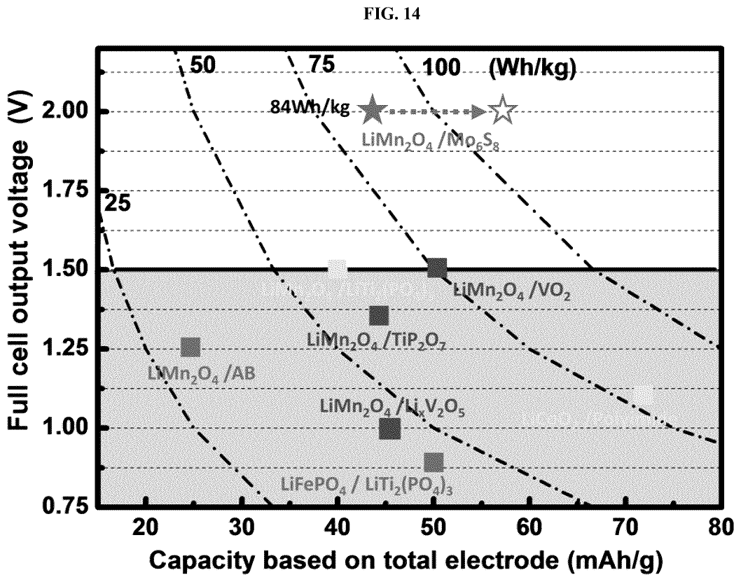

As shown in FIG. 13A, the full-cell is fully charged to 2.3 V, and then the open circuit voltage is recorded versus the standing time to evaluate the self-discharge of full-cell in fully charge. After 2 days, the open circuit voltage is still above 2.0 V which evidently demonstrates low self-discharge and thus, a highly stable electrolyte. Thus, there was hardly any chemical reaction between the full dilithiation anode and electrolyte. In order to avoid consuming excess LiMn₂O₄ by the first irreversibly capacity of anode, the Mo₃S₄ electrode after 5 cycles in full-cell is selected to match the Mo₃S₄ electrode with a mass ratio of 1:1. As shown in FIG. 14, the full-cell delivers a very high energy density of 100 Wh/kg based on discharge capacity (55 mA/g) and two output voltages (1.5 and 2.0 V).

Generally speaking, the four performance parameters used for evaluating the full-cell configuration of an aqueous rechargeable lithium battery include output voltage, capacity based on total electrode, coulombic efficiency, and cycling number. The first two indexes determinate the energy density and the latter two indicate the lifetime of the battery. Here, we summarize those three performance indexes for the full-cell configurations of previously reported aqueous lithium ion batteries in FIG. 14.

The index of cycling life is assigned to previously reported aqueous lithium ion batteries: (1) cycle number N<100 cycles for LiMn₂O₄/VO₂, LiMn₂O₄/TiP₂O₇, and LiMn₂O₄/LiₓV₂O₅, (2) cycle number 100<N<200 cycles for LiMn₂O₄/LiTi₂(PO₄)₃ and LiCOO₂/polyimide; and (3) cycle number of N>1000 cycles for LiMnO₂O₄/AB and LiFePO₄/LiTi₂(PO₄)₃. To date, only the hybrid batteries LiMnO₂O₄/AB and LiFePO₄/LiTi₂(PO₄)₃ with eliminating O₂ electrolyte, achieved long cycling exceeding 1000 cycles; however, due to sacrificing the energy density, the advantages of aqueous rechargeable lithium batteries are also weakened. With an index of output voltage of about 2.0 V, aqueous lithium ion batteries are more competitive than other kinds of aqueous electrochemical storage systems. With reference to the current lithium ion batteries manufacturing level (inactive substance accounts for at least 40%), the estimated energy density in practical aqueous batteries will deliver above 60 Wh/kg which is not only higher than all current aqueous rechargeable lithium batteries previously reported in the literature, but also shows an obvious advantage in comparison with other aqueous batteries (Ni-H, Pd-acid, with a Wh/kg of about 30-40).

As for the excellent electrochemical performances shown, especially the cycle life at a low rate and open circuit voltage recorded at the fully charge state, it seems not enough just only by contribution to dynamic condition, but possibly the formation of a stable solid electrolyte interphase (SEI) layer on the anode as occurs with organic lithium ion batteries.

### Example 4

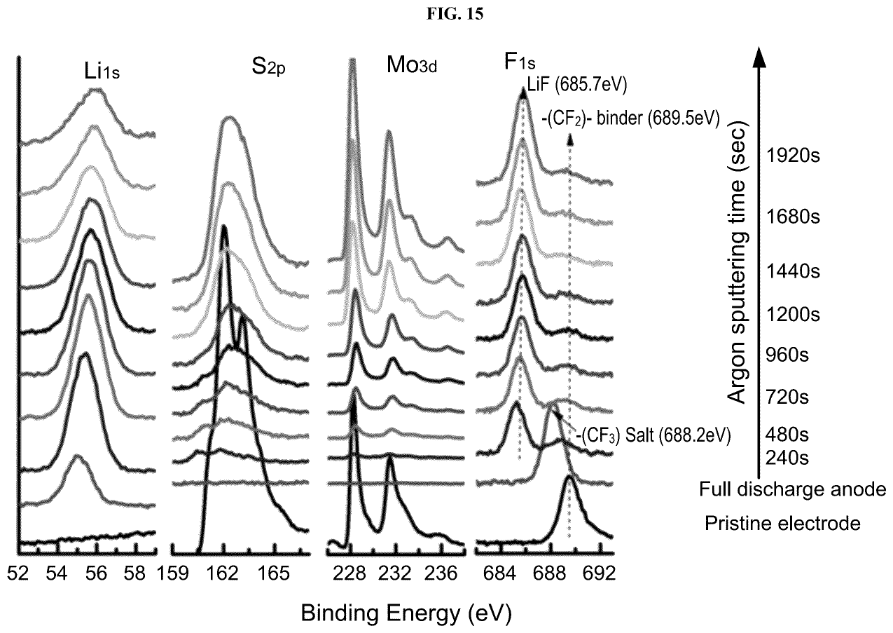

To confirm whether a SEI layer formed on the surface of the anode, surfaces of an anode after full lithiation in a full-cell configuration were studied by ex situ X-ray photoelectron spectroscopy (FIG. 15). Compared with the pristine Mo₃S₄ electrode with obvious Mo_{3d} and S₂ₚ characteristic signals and the F1s signal belonging to a polytetrafluoroethylene (PTFE) binder, after full charge of the full-cell to 2.3 V, the Mo_{3d} and S₂ₚ signals of Mo₃S₄ disappeared which manifested directly that SEI was forming on the anode. Subsequently, we did depth profiling analysis of the full lithiation anode. It showed that, with increasing argon ion sputtering times, the SEI layer was etched gradually and Mo₃S₄ signals enhanced constantly. At the same time, an amount of LiF was detected by XPS which is the main component of the SEI layer.

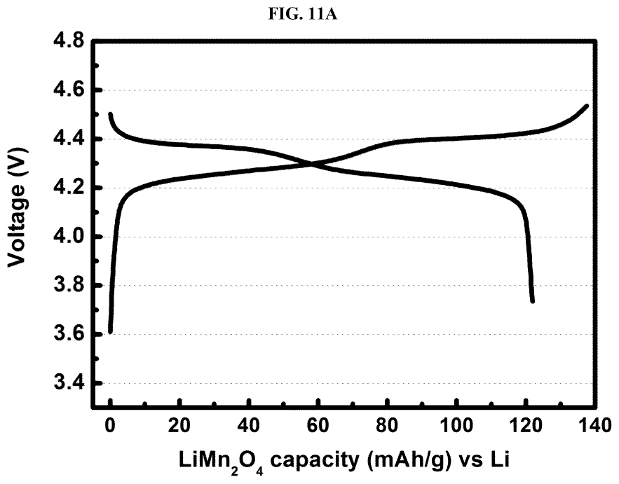

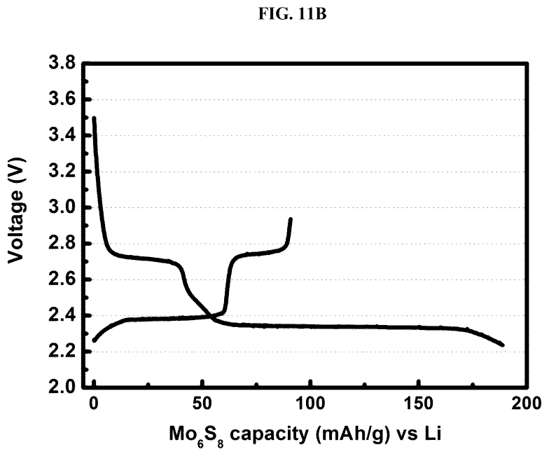

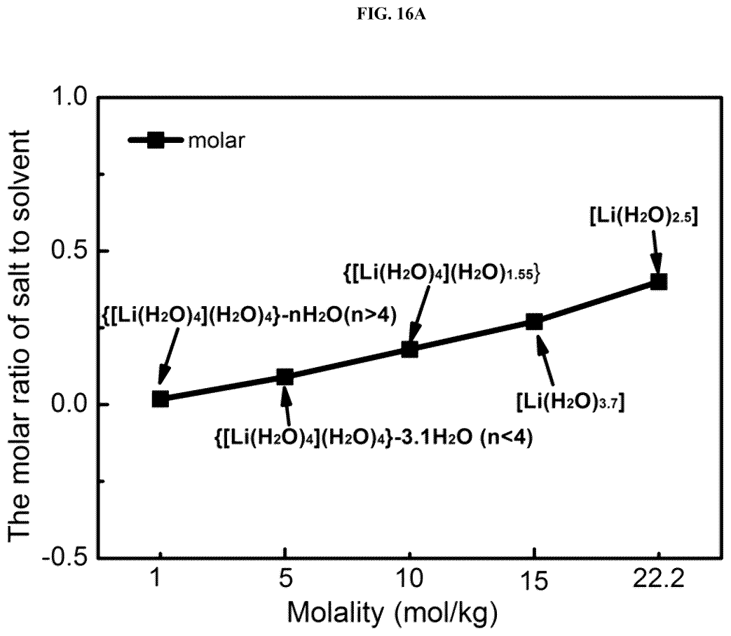

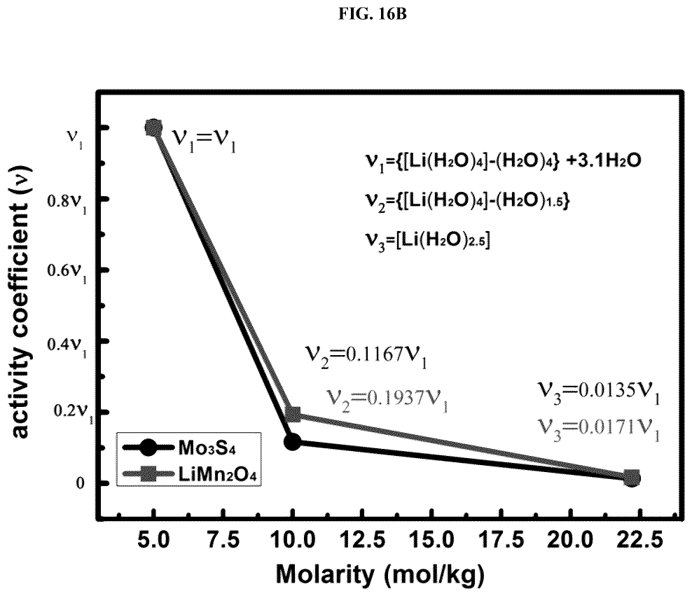

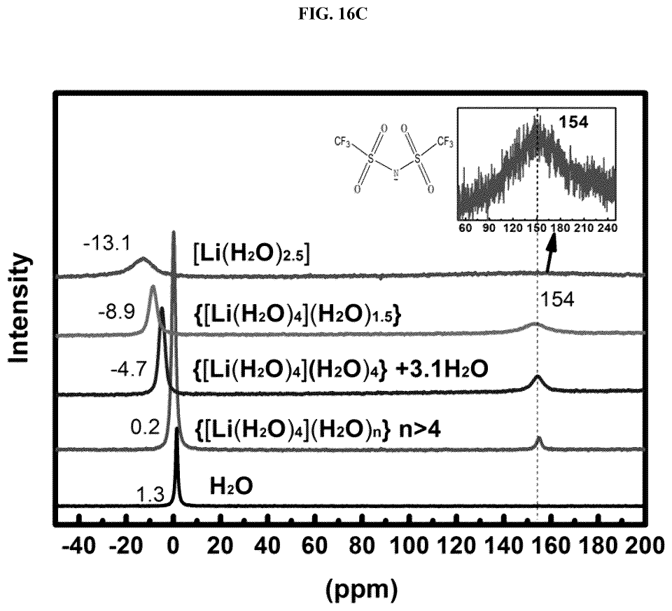

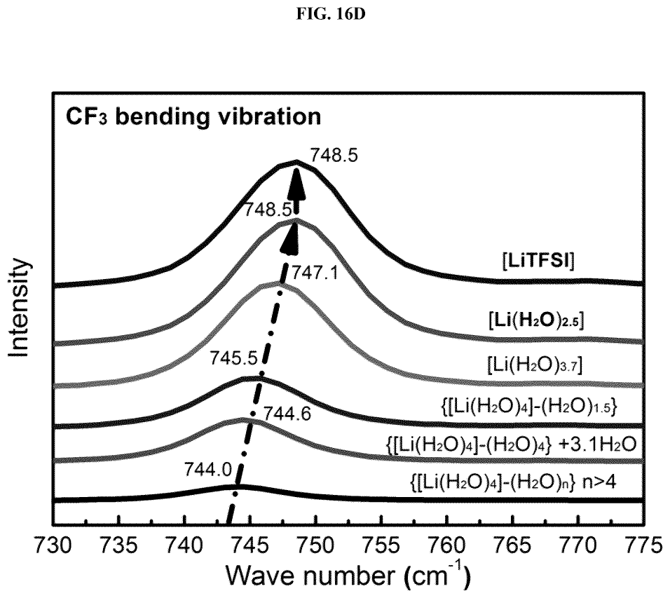

As shown by FIGS. 9A-D, FIGS. 10A-C, and FIGS. 11A-B, with the changing salt fractions in solution, the lithium ion activity goes through tremendous changes owing to the effect on the interaction between cation and anion or ion and water. Thus, investigation of the activity coefficients is particularly helpful to understand the behavior of water-in-salt electrolyte solutions. Based on cyclic voltammetry data in FIGS. 10A-C, the relative activity coefficient ratio of different electrolytes was calculated (FIG. 16B).

### Example 5

In order to investigate the cation-anion or ion-solvent interaction in a LiTFSI-H₂O binary electrolyte system, Raman spectroscopy and O¹⁷ NMR were applied to study the cation-anion interaction and ion-solvent interaction, respectively. The interaction between cation and anion is detected by Raman spectra of electrolyte with different ratio of LiTFSI to H₂O (FIG. 16D). It is clearly found that the strongest peak is at 747 cm⁻¹, corresponding to the bending vibration of the CF₃ group. This peak is considered the most evident and sensitive to the change by the ratio of solvent to salt in all peaks, so, it could be used to describe and analyze the interaction between cation and anion. As shown in FIG. 16D, with the increasing ratio of salt to solvent, the peak of the CF₃ bending vibration gradually shifted to a high wave number and with the highest intensity belonging to a pure LiTFSI salt which means that interaction of cation and anion becomes stronger and stronger. In solution, the dissolved cation and anion commonly forms ion-pairs. In very dilute solution, due to strong Li hydration, there is nearly no interaction between cation and anion which is defined as a free ion. With an increase in salt concentration, loose pairing occurs because a small amount of anion has a chance to inter with cation hydration. If the ratio of salt to solvent increases more, the intimate pair will play a major role in the electrolyte, thus shifting the Raman peak of CF₃ the same as in pure LiTFSI salt.

As shown by O¹⁷ NMR (FIG. 16C), 154 ppm is considered to belong to the O element of TFSI− which is not influenced by the increasing ratio of LiTFSI to water. On the contrary, the signal of H₂O shifted in the negative direction drastically, due to the great change of Li ion hydration structure with increasing ratio of LiTFSI to H₂O.

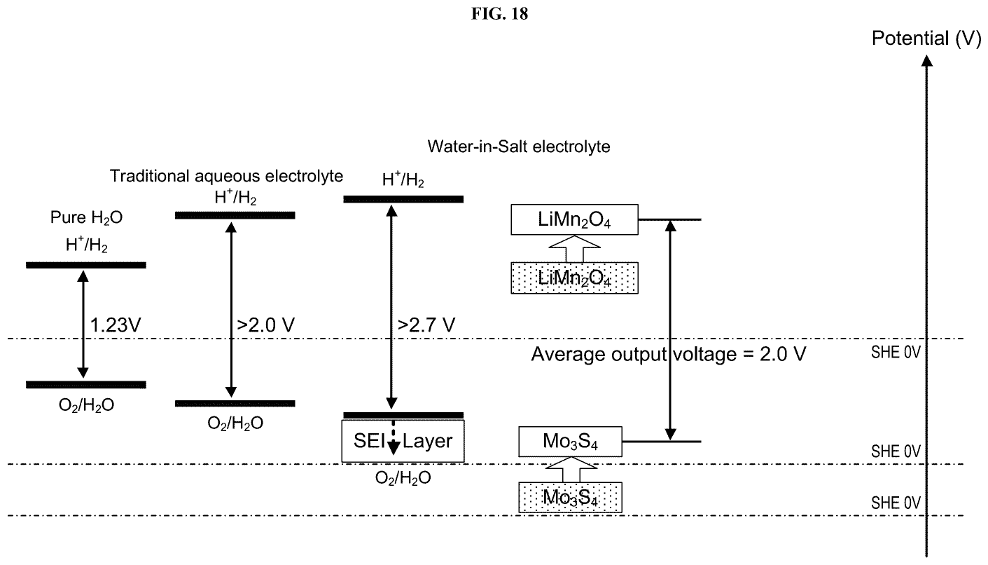

In the conventional view of the hydration Li ion structure in dilute solution (Marcus, Y., et al., Chemical Reviews 109(3):1346-1370 (2009) and Ohtaki, H., et al., Chemical Reviews 93(3):1157-1204 (1993)) (FIGS. 18A-B), there are two shell-sheaths surrounding Li ion, and every sheath is comprised of four water molecules which is similar to the lithium ion organic electrolyte (Bogle, X., et al., J. Physical Chem. Letters 4(10):1664-1668 (2013)). However, in the water-in-salt electrolyte at 22.2 M, the ratio of LiTFSI to water is 2.5, which is not enough to from a hydration structure with 4 ordination number. Thus, in this case, the Li electrostatic field cannot be shielded by H₂O molecules which causes the direct interaction between Li⁺ and TFSI⁻, which could be considered as contact ion pairs (CIP) and cation-anion aggregates (AGG).

It is generally accepted that SEI is unable to form in an aqueous electrolyte due to H₂O decomposition into gas (O₂ and H₂) which cannot contribute to SEI formation and salt reduction potential lower than H₂O hydrogen evolution. To our knowledge, this is the first work reporting stable SEI formation in an aqueous rechargeable lithium battery which could extend the aqueous electrolyte window into −1.3 V in a neural electrolyte.

The origin of SEI formation was derived from two factors: (1) the high solvation energy of H₂O-in-LiTFSI effectively reduced the gas product of water decomposition (O₂ and H₂) which is favorable to make salt decomposition products adhere to the surface of the anode; and (2) the strong interaction between cation and anion formed a large amount of contact ion pairs (CIP) and cation-anion aggregates (AGG) in electrolyte which had a higher reduction potential (2.4 V) than free TFSI⁻(1.8 V) in low concentration solution. Thus, salt decomposed to form a stable SEI layer in the charge-discharge process.

Having now fully described this invention, it will be understood by those of ordinary skill in the art that the same can be performed within a wide and equivalent range of conditions, formulations and other parameters without affecting the scope of the invention or any embodiment thereof.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

All patents and publications cited herein are fully incorporated by reference herein in their entirety.

1. An aqueous electrolyte composition that is formulated to have a melt temperature of less than −40° C., said aqueous electrolyte composition is a water-in-salt electrolyte composition comprising:
an electrolyte salt;
a solvent comprising water; and
a non-aqueous solvent.

2. The aqueous electrolyte composition of claim 1, wherein said non-aqueous solvent comprises an ether, glyme, di-glyme, tri-glyme, tetra-glyme, a carbonate, a formate, butyrolactone, hexamethylphosphoramide, pyridine, N,N-diethylacetamide (DMAC), N,N-diethylformamide, dimethylsulfoxide (DMSO), tetramethylurea (TMU), N,N-dimethylacetamide, N,N-dimethylformamide (DMF), tributylphosphate, trimethylphosphate, N,N,N′,N′-tetraethylsulfamide, tetraethylenediamine, tetramethylpropylenediamine, pentamethyldiethylenetriamine, or combination thereof.

3. The aqueous electrolyte composition of claim 1, wherein said non-aqueous solvent comprises propylene carbonate (PC), ethylene carbonate (EC), dimethyl carbonate (DMC), ethylmethyl carbonate (EMC), diethyl carbonate (DEC), methyl formate, butyrolactone, hexamethylphosphoramide, pyridine, N,N-diethylacetamide (DMAC), or a combination thereof.

4. The aqueous electrolyte composition of claim 1, wherein said non-aqueous solvent has a donor number of at least 15.

5. The aqueous electrolyte composition of any one of claims 1-4, wherein said electrolyte salt comprises LiN(SO₂CF₃)₂, LiN(SO₂CH₃)₂, LiN(SO₂C₄H₉)₂, LiN(SO₂C₂F₅)₂, LiN(SO₂C₄F₉)₂, LiN(SO₂F₃)(SO₂C₄F₉), LiN(SO₂C₂F₅)(SO₂C₄F₉), LiN(SO₂C₂F₄SO₂), LiN(SO₂F), LiN(SO₂F)(SO₂CF₃), LiPF₆, LiSO₃CF₃, or a combination thereof.

6. The aqueous electrolyte composition of any one of claims 1-4, wherein a volume percent of water in said electrolyte composition relative to a total liquid solvent volume is greater than 5%.

7. The aqueous electrolyte composition of any one of claims 1-4, wherein a volume percent of water in said electrolyte composition relative to a total liquid solvent volume is between 5% and 90%.

8. The aqueous electrolyte composition of any one of claims 1-4, wherein a pH of the aqueous electrolyte composition is between pH 7 and pH 11.

9. An aqueous electrochemical cell comprising an aqueous electrolyte composition, wherein said aqueous electrochemical cell has an operating temperature range of from −40° C. to 100° C., and wherein said aqueous electrolyte composition is a water-in-salt electrolyte composition that comprises an electrolyte salt, a solvent comprising water, and a second solvent selected from the group consisting of an organic solvent, an ionic liquid, and a combination thereof.

10. The aqueous electrochemical cell of claim 9, wherein said second solvent is an aprotic organic solvent.

11. The aqueous electrochemical cell of claim 9, wherein said aqueous electrolyte composition comprises a lithium electrolyte salt.

12. The aqueous electrochemical cell of claim 9, wherein said aqueous electrolyte composition comprises LiN(SO₂CF₃)₂, LiN(SO₂CH₃)₂, LiN(SO₂C₄H₉)₂, LiN(SO₂C₂F₅)₂, LiN(SO₂C₄F₉)₂, LiN(SO₂F₃)(SO₂C₄F₉), LiN(SO₂C₂F₅)(SO₂C₄F₉), LiN(SO₂C₂F₄SO₂), LiN(SO₂F), LiN(SO₂F)(SO₂CF₃), LiPF₆, LiSO₃CF₃, or a combination thereof.

13. The aqueous electrochemical cell of any one of claims 9-12 further comprising an ionic liquid.

14. The aqueous electrochemical cell of any one of claims 9-12 further comprising an ether, glyme, di-glyme, tri-glyme, tetra-glyme, a carbonate, a formate, butyrolactone, hexamethylphosphoramide, pyridine, N,N-diethylacetamide (DMAC), N,N-diethylformamide, dimethylsulfoxide (DMSO), tetramethylurea (TMU), N,N-dimethylacetamide, N,N-dimethylformamide (DMF), tributylphosphate, trimethylphosphate, N,N,N′,N′-tetraethylsulfamide, tetraethylenediamine, tetramethylpropylenediamine, pentamethyldiethylenetriamine, or combination thereof.

15. The aqueous electrochemical cell of any one of claims 9-12 further comprising propylene carbonate (PC), ethylene carbonate (EC), dimethyl carbonate (DMC), ethylmethyl carbonate (EMC), diethyl carbonate (DEC), methyl formate, butyrolactone, hexamethylphosphoramide, pyridine, N,N-diethylacetamide (DMAC), or a combination thereof.
